(19) United States
(12) Patent Application Publication
(10) Pub. No.: US 2025/0327989 A1
(43) Pub. Date: Oct. 23, 2025

(54) OPTICAL SYSTEM, OPTICAL DEVICE, INTERCHANGEABLE LENS, AND METHOD FOR MANUFACTURING OPTICAL SYSTEM

(71) Applicant: NIKON CORPORATION, Tokyo (JP)

(72) Inventors: Mami MURATANI, Tokyo (JP); Hiroshi Yamamoto, Tokyo (JP); Tomonori Kuribayashi, Tokyo (JP); Takuro Ono, Tokyo (JP)

(21) Appl. No.: 19/258,356

(22) Filed: Jul. 2, 2025

Related U.S. Application Data
(63) Continuation of application No. PCT/JP2023/044790, filed on Dec. 14, 2023.

(30) Foreign Application Priority Data
Jan. 6, 2023 (JP) 2023-000837

(51) Int. Cl. G02B 9/10; G02B 3/00; G02B 3/04; H04N 23/55

(52) U.S. Cl. CPC G02B 9/10; G02B 3/0043; G02B 3/04; H04N 23/55

(57) ABSTRACT

An optical system of the present disclosure includes, in order from an object side, a front lens group having positive refractive power, an aperture stop, and a rear lens group. The optical system satisfies the following conditional expressions.

$$0.1 < ff / \vert fr \vert < 1.5$$

$$0.13 < tr / TL < 0.45$$

$$0.5 < f / TL < 1.2$$

where ff is the focal length of the front lens group; fr is the focal length of the rear lens group; tr is the sum of the central thicknesses of the lenses included in the rear lens group; TL is the total length of the optical system; and f is the focal length of the optical system.

### CROSS-REFERENCE TO RELATED APPLICATIONS

This application is a continuation of International Patent Application No. PCT/JP2023/044790 filed Dec. 14, 2023, which claims priority from Japanese Patent Application No. 2023-000837 filed Jan. 6, 2023, and which are incorporated herein by reference.

### FIELD

The present disclosure relates to an optical system, an optical device, an interchangeable lens, and a method of manufacturing an optical system.

### BACKGROUND

Optical systems used in optical devices, such as cameras for photographs, electronic still cameras, and video cameras, have been proposed (see, e.g., International Publication No. 2019/187633).

### SUMMARY

An optical system of the present disclosure includes, in order from an object side, a front lens group having positive refractive power, an aperture stop, and a rear lens group. The optical system satisfies the following conditional expressions.

$$0.10 < ff / \vert fr \vert < 1.5 \\ 0.13 < tr / TL < 0.45 \\ 0.5 < f / TL < 1.2$$

where
ff: the focal length of the front lens group
fr: the focal length of the rear lens group
tr: the sum of the central thicknesses of the lenses included in the rear lens group
TL: the total length of the optical system
f: the focal length of the optical system

A method for manufacturing an optical system of the present disclosure includes configuring an optical system including, in order from an object side, a front lens group having a positive refractive power, an aperture stop, and a rear lens group, and the following conditional expressions are satisfied.

$$0.10 < ff / \vert fr \vert < 1.5 \\ 0.13 < tr / TL < 0.45 \\ 0.5 < f / TL < 1.2$$

where
ff: the focal length of the front lens group
fr: the focal length of the rear lens group
tr: the sum of the central thicknesses of the lenses included in the rear lens group
TL: the total length of the optical system
f: the focal length of the optical system

### BRIEF DESCRIPTION OF THE DRAWINGS

FIG. 1 is a cross-sectional view of an optical system of a first example focusing on an object at infinity.

FIG. 2 shows aberrations of the optical system of the first example.

FIG. 3 is a cross-sectional view of an optical system of a second example focusing on an object at infinity.

FIG. 4 shows aberrations of the optical system of the second example.

FIG. 5 is a cross-sectional view of an optical system of a third example focusing on an object at infinity.

FIG. 6 shows aberrations of the optical system of the third example.

FIG. 7 is a cross-sectional view of an optical system of a fourth example focusing on an object at infinity.

FIG. 8 shows aberrations of the optical system of the fourth example.

FIG. 9 is a cross-sectional view of an optical system of a fifth example focusing on an object at infinity.

FIG. 10 shows aberrations of the optical system of the fifth example.

FIG. 11 is a cross-sectional view of an optical system of a sixth example focusing on an object at infinity.

FIG. 12 shows aberrations of the optical system of the sixth example.

FIG. 13 is a cross-sectional view of an optical system of a seventh example focusing on an object at infinity.

FIG. 14 shows aberrations of the optical system of the seventh example.

FIG. 15 is a cross-sectional view of an optical system of an eighth example focusing on an object at infinity.

FIG. 16 shows aberrations of the optical system of the eighth example.

FIG. 17 is a cross-sectional view of an optical system of a ninth example focusing on an object at infinity.

FIG. 18 shows aberrations of the optical system of the ninth example.

FIG. 19 is a cross-sectional view of an optical system of a tenth example focusing on an object at infinity.

FIG. 20 shows aberrations of the optical system of the tenth example.

FIG. 21 schematically shows a camera including an optical system of the embodiment.

FIG. 22 Is a flowchart outlining a method for manufacturing an optical system of the embodiment.

### DESCRIPTION OF EMBODIMENTS

The following describes an optical system, an optical device, and a method for manufacturing an optical system of an embodiment of the present application.

An optical system of the present embodiment includes, in order from an object side, a front lens group having a positive refractive power, an aperture stop, and a rear lens group, and satisfies the following conditional expressions.

$$0.10 < ff / \vert fr \vert < 1.5 \qquad ( 1 )$$

$$0.13 < tr / TL < 0.45 \qquad ( 2 )$$

$$0.5 < f / TL < 1.2 \qquad ( 3 )$$

where ff: the focal length of the front lens group fr: the focal length of the rear lens group tr: the sum of the central thicknesses of the lenses included in the rear lens group TL: the total length of the optical system f: the focal length of the optical system

The optical system of the present embodiment can have a shorter total length with respect to the focal length by the front lens group having a positive refractive power, enabling the principal point closer to the object side.

Conditional expression (1) restricts the ratio of the focal length of the front lens group to the focal length of the rear lens group. The optical system of the present embodiment, which satisfies conditional expression (1), can appropriately correct aberrations including spherical aberration, coma aberration, field curvature, and distortion while suppressing enlargement of the optical system.

If the value of conditional expression (1) exceeds the upper limit in the optical system of the present embodiment, the refractive power of the front lens group will be too strong, and making it difficult to appropriately correct aberrations including high-order spherical aberration, coma aberration, field curvature, and distortion.

The effect of the present embodiment can be ensured by setting the upper limit of conditional expression (1) to 1.50 in the optical system of the present embodiment. To further ensure the effect of the present embodiment, the upper limit of conditional expression (1) is preferably set to 1.40, 1.30, 1.20, or 1.10, more preferably to 1.00.

If the value of conditional expression (1) is below the lower limit in the optical system of the present embodiment, the refractive power of the front lens group will be too weak, and the optical system will become larger with the longer total length and the larger lens diameter.

The effect of the present embodiment can be ensured by setting the lower limit of conditional expression (1) to 0.10 in the optical system of the present embodiment. To further ensure the effect of the present embodiment, the lower limit of conditional expression (1) is preferably set to 0.15 or 0.19, more preferably to 0.40.

Conditional expression (2) restricts the ratio the sum of the respective central thicknesses of the lenses included in the rear lens group to the total length of the optical system. The optical system of the present embodiment, which satisfies conditional expression (2), can suppress an increase in size and weight of the optical system.

If the value of conditional expression (2) exceeds the upper limit in the optical system of the present embodiment, the lens thickness will increase, and thus the weight of the optical system will increase.

The effect of the present embodiment can be ensured by setting the upper limit of conditional expression (2) to 0.45 in the optical system of the present embodiment. To further ensure the effect of the present embodiment, the upper limit of conditional expression (2) is preferably set to 0.40 or 0.35, more preferably to 0.30.

If the value of conditional expression (2) is below the lower limit in the optical system of the present embodiment, the optical system will become larger with longer total length.

The effect of the present embodiment can be ensured by setting the lower limit of conditional expression (2) to 0.13 in the optical system of the present embodiment. To further ensure the effect of the present embodiment, the lower limit of conditional expression (2) is preferably set to 0.14, 0.15 or 0.16, more preferably to 0.17.

Conditional expression (3) restricts the ratio of the focal length of the optical system to the total length of the optical system. The optical system of the present embodiment, which satisfies conditional expression (3), can appropriately correct aberrations including spherical aberration, coma aberration, field curvature, and distortion while suppressing enlargement of the optical system.

If the value of conditional expression (3) exceeds the upper limit in the optical system of the present embodiment, it will be difficult to appropriately correct aberrations including spherical aberration, coma aberration, field curvature, and distortion.

In the optical system of the present embodiment, the effect of the present embodiment can be ensured by setting the upper limit of conditional expression (3) to 1.20. To further ensure the effect of the present embodiment, the upper limit of conditional expression (3) is preferably set to 1.15, 1.10 or 1.05, more preferably to 1.00.

If the value of conditional expression (3) is below the lower limit in the optical system of the present embodiment, the optical system will become larger with longer total length.

The effect of the present embodiment can be ensured by setting the lower limit of conditional expression (3) to 0.50 in the optical system of the present embodiment. To further ensure the effect of the present embodiment, the lower limit of conditional expression (3) is preferably set to 0.55, 0.60, 0.65 or 0.70, more preferably to 0.80.

An optical system of the present embodiment, which satisfies conditional expression (1), (2), and (3) can appropriately correct aberrations including spherical aberration, coma aberration, field curvature, and distortion while suppressing an increase in size and weight of the optical system.

In the optical system of the present embodiment, the rear lens group preferably has a negative refractive power.

In the optical system of the present embodiment, which has such a configuration, the total length of the optical system can be shortened, and the spherical aberration can be appropriately corrected.

The optical system of the present embodiment preferably satisfies the following conditional expression.

$$0.05 < fPr / \vert fr \vert < 0. 70 \qquad ( 4 )$$

where
fPr: the focal length of a single lens Pr having the strongest refractive power among the biconvex single lenses in the rear lens group

Conditional Expression (4) restricts the ratio of the focal length of the single lens Pr having the strongest refractive power among the biconvex single lenses in the rear lens group to the focal length of the rear lens group. The optical system of the present embodiment, which satisfies conditional expression (4), can appropriately correct aberrations including coma aberration and field curvature while suppressing an increase in the size of the optical system.

If the value of conditional expression (4) exceeds the upper limit in the optical system of the present embodiment, the refractive power of the rear lens group will become too weak, the optical system will become larger with longer total length and larger lens diameter.

In the optical system of the present embodiment, the effect of the present embodiment can be ensured by setting the upper limit of conditional expression (4) to 0.70. To further ensure the effect of the present embodiment, the upper limit of conditional expression (4) is preferably set to 0.65 or 0.60, more preferably to 0.40.

If the value of conditional expression (4) is below the lower limit in the optical system of the present embodiment, the refractive power of the single-lens Pr will become too strong, making it difficult to appropriately correct aberrations including high-order coma aberration and field curvature.

In the optical system of the present embodiment, the effect of the present embodiment can be ensured by setting the lower limit of conditional expression (4) to 0.05. To further ensure the effect of the present embodiment, the lower limit of conditional expression (4) is preferably set to 0.06, 0.07, 0.08, 0.09 or 0.10, more preferably to 0.20.

The optical system of the present embodiment preferably has at least one focusing group configured to move at focusing, and satisfies the following conditional expression.

$$0.05 < fPfoi / \vert fr \vert < 0. 50 \qquad ( 5 )$$

where
fPfoi: the focal length of a single lens Pfoi having the strongest refractive power among the biconvex single lenses disposed closer to the image plane side than the focusing group Gfo disposed closest to the object side among at least one focusing group

Conditional expression (5) restricts the ratio of the focal length of the single-lens Pfoi to the focal length of the rear lens group. The optical system of the present embodiment, which satisfies conditional expression (5), can reduce the occurrence of spherical aberration, coma aberration, and field curvature, while suppressing enlargement of the optical system.

If the value of conditional expression (5) exceeds the upper limit in the optical system of the present embodiment, the refractive power of the single lens fPfoi will become too weak, and the total length of the optical system will become too long.

In the optical system of the present embodiment, the effect of the present embodiment can be ensured by setting the upper limit of conditional expression (5) to 0.70. To further ensure the effect of the present embodiment, the upper limit of conditional expression (5) is preferably set to 0.65 or 0.60, more preferably to 0.40.

If the value of conditional expression (5) is lower than the lower limit in the optical system of the present embodiment, the refractive power of the single-lens Pfoi will become too strong, making it difficult to appropriately correct aberrations including spherical aberration, coma aberration, and field curvature.

In the optical system of the present embodiment, the effect of the present embodiment can be ensured by setting the lower limit of conditional expression (5) to 0.05. To further ensure the effect of the present embodiment, the lower limit of conditional expression (5) is preferably set to 0.06, 0.07, 0.08, 0.09 or 0.10, more preferably to 0.20.

The optical system of the present embodiment preferably has at least one focusing group configured to move at focusing, and satisfies the following conditional expression.

$$25 < fPfoi / f < 0.55 \qquad ( 6 )$$

Conditional expression (6) restricts the ratio of the focal length of the single-lens Pfoi to the focal length of the optical system. The optical system of the present embodiment, which satisfies conditional expression (6), can reduce the occurrence of spherical aberration, coma aberration, and field curvature, while suppressing enlargement of the optical system.

If the value of conditional expression (6) exceeds the upper limit in the optical system of the present embodiment, the refractive power of the single lens Pfoi will become too weak, and the optical system will become larger with longer total length and larger lens diameter. If the value of conditional expression (6) exceeds the upper limit, it will be difficult to appropriately correct aberrations including spherical aberration, coma aberration, and field curvature.

The effect of the present embodiment can be ensured by setting the upper limit of conditional expression (6) to 0.55 in the optical system of the present embodiment. To further ensure the effect of the present embodiment, the upper limit of conditional expression (6) is preferably set to 0.50, 0.48 or 0.46, more preferably to 0.40.

If the value of conditional expression (6) is lower than the lower limit in the optical system of the present embodiment, the refractive power of the single-lens Pfoi will become too strong, making it difficult to appropriately correct aberrations including spherical aberration, coma aberration, and field curvature.

The effect of the present embodiment can be ensured by setting the lower limit of conditional expression (6) to 0.25 in the optical system of the present embodiment. To further ensure the effect of the present embodiment, the lower limit of conditional expression (6) is preferably set to 0.28 or 0.30, more preferably to 0.31.

The optical system of the present embodiment preferably satisfies the following conditional expression.

$$0.05 < Da / Bf < 1.10 \qquad ( 7 )$$

where
Da: the distance on the optical axis between a lens surface on the object side of a lens Li1 disposed closest to the image plane side and a lens surface on the image plane side of a lens Li2 disposed adjacent to the object side of the lens Li1 at focusing on infinity
Bf: back focal length in air

Conditional expression (7) restricts the ratio of the distance on the optical axis between the lens surface on the object side of the lens Li1 and the lens surface on the image plane side of the lens Li2 at focusing on infinity to a back focal length in air of the optical system. The optical system of the present embodiment, which satisfies conditional expression (7), can appropriately correct aberrations including field curvature, coma aberration, and distortion.

If the value of conditional expression (7) exceeds the upper limit in the optical system of the present embodiment, it will be difficult to appropriately correct the field curvature and the coma aberration.

In the optical system of the present embodiment, the effect of the present embodiment can be ensured by setting the upper limit of conditional expression (7) to 1.10. To further ensure the effect of the present embodiment, the upper limit of conditional expression (7) is preferably set to 1.05, more preferably to 1.00.

If the value of conditional expression (7) is below the lower limit in the optical system of the present embodiment, it will be difficult to appropriately correct the field curvature and the distortion.

The effect of the present embodiment can be ensured by setting the lower limit of conditional expression (7) to 0.05 in the optical system of the present embodiment. To further ensure the effect of the present embodiment, the lower limit of conditional expression (7) is preferably set to 0.06, more preferably to 0.07.

Preferably, the rear lens group includes a plurality of lens groups including at least one focusing group that moves at focusing, and the distances between the lens groups are varied at focusing, and the optical system of the present embodiment satisfies the following conditional expression.

$$0.30 < tGi / Da < 9.00 \qquad ( 8 )$$

where
tGi: the sum of the lengths on the optical axis of the respective lenses included in a lens group Gi disposed closest to the image plane among the plurality of lens groups

Conditional Expression (8) restricts the ratio of the sum of the lengths on the optical axis of the lens included in the lens group Gi to the distance on the optical axis between the lens surface on the object side of the lens Li1 and the lens surface on the image plane side of the lens Li2 at focusing on infinity. The optical system of the present embodiment, which satisfies conditional expression (8), can appropriately correct aberrations including field curvature and distortion while suppressing an increase in the weight of the optical system.

If the value of conditional expression (8) exceeds the upper limit in the optical system of the present embodiment, the lens thickness of the lens group Gi will become too large, and the weight of the optical system will increase.

The effect of the present embodiment can be ensured by setting the upper limit of conditional expression (8) to 9.00 in the optical system of the present embodiment. To further ensure the effect of the present embodiment, the upper limit of conditional expression (8) is preferably set to 8.50, 8.00, 7.80 or 7.60, more preferably to 3.00.

If the value of conditional expression (8) is below the lower limit in the optical system of the present embodiment, it will be difficult to appropriately correct aberrations including field curvature and distortion.

The effect of the present embodiment can be ensured by setting the lower limit of conditional expression (8) to 0.30 in the optical system of the present embodiment. To further ensure the effect of the present embodiment, the lower limit of conditional expression (8) is preferably set to 0.32, 0.34, 0.60 or 1.00, more preferably to 1.50.

The optical system of the present embodiment preferably satisfies the following conditional expression.

$$0.4 < D 1 / TL < 0.85 \qquad ( 9 )$$

where

D1: the distance on the optical axis between the lens surface closest to the object side and the object-side surface of the single lens Pr having the strongest refractive power among biconvex single lenses in the rear lens group at focusing on infinity

Conditional expression (9) restricts the ratio of the distance on the optical axis between the lens surface closest to the object side and the object-side lens surface of the single lens Pr at focusing on infinity to the total length of the optical system. The optical system of the present embodiment, which satisfies conditional expression (9), can appropriately correct aberrations including spherical aberration, coma aberration, field curvature, and distortion while suppressing enlargement of the optical system.

If the value of conditional expression (9) exceeds the upper limit in the optical system of the present embodiment, the refractive power between the lens surface closest to the object side and the object-side lens surface of the single lens Pr will become too weak, and the optical system will become larger with larger lens diameters.

The effect of the present embodiment can be ensured by setting the upper limit of conditional expression (9) to 0.85 in the optical system of the present embodiment. To further ensure the effect of the present embodiment, the upper limit of conditional expression (9) is preferably set to 0.84 or 0.82, more preferably to 0.80.

If the value of conditional expression (9) is below the lower limit in the optical system of the present embodiment, the refractive power between the lens surface closest to the object side and the object-side lens surface of the single lens Pr will become too strong, and making it difficult to appropriately correct aberrations including high-order spherical aberration, coma aberration, field curvature, and distortion.

The effect of the present embodiment can be ensured by setting the lower limit of conditional expression (9) to 0.40 in the optical system of the present embodiment. To further ensure the effect of the present embodiment, the lower limit of conditional expression (9) is preferably set to 0.45, more preferably to 0.50.

The optical system of the present embodiment preferably satisfies the following conditional expression.

$$0.10 < D 2 / TL < 0.80 \qquad ( 10 )$$

where

D2: the distance on the optical axis between the aperture stop and the object-side lens surface of the single lens Pr having the strongest refractive power among biconvex single lenses in the rear lens group

Conditional expression (10) restricts the ratio of the distance on the optical axis between the aperture stop and the object-side lens surface of the single lens Pr to the total length of the optical system. The optical system of the present embodiment, which satisfies conditional expression (10), can appropriately correct aberrations including spherical aberration, coma aberration, field curvature, and distortion while suppressing enlargement of the optical system.

If the value of conditional expression (10) exceeds the upper limit in the optical system of the present embodiment, the refractive power between the aperture stop and the object-side lens surface of the single lens Pr will become too weak, and the optical system will become larger in size with larger lens diameters.

The effect of the present embodiment can be ensured by setting the upper limit of conditional expression (10) to 0.80 in the optical system of the present embodiment. To further ensure the effect of the present embodiment, the upper limit of conditional expression (10) is preferably set to 0.70, 0.60, 0.50 or 0.40, more preferably to 0.36.

If the value of conditional expression (10) is lower than the lower limit in the optical system of the present embodiment, the refractive power between the aperture stop and the object-side lens surface of the single lens Pr will become too strong, and it will become difficult to appropriately correct aberrations including high-order spherical aberration, coma aberration, field curvature, and distortion.

The effect of the present embodiment can be ensured by setting the lower limit of conditional expression (10) to 0.10 in the optical system of the present embodiment. To further ensure the effect of the present embodiment, the lower limit of conditional expression (10) is preferably set to 0.11 or 0.12, more preferably to 0.13.

Preferably, the optical system of the present embodiment has at least one focusing group that moves at focusing, and satisfies the following conditional expression.

$$0.25 < \vert ffo \vert / f < 0.90 \qquad ( 11 )$$

where
ffo: the focal length of a focusing group Gfo disposed closest to the object side among the at least one focusing group

Conditional expression (11) restricts the ratio of the focal length of the focusing group Gfo disposed closest to the object to the focal length of the optical system. The optical system of the present embodiment, which satisfies conditional expression (11), can appropriately correct aberrations including spherical aberration, coma aberration, field curvature, and distortion while suppressing an increase in the overall length of the optical system.

If the value of conditional expression (11) exceeds the upper limit in the optical system of the present embodiment, it will be difficult to suppress variations in aberrations including spherical aberration, coma aberration, field curvature, and distortion at focusing.

The effect of the present embodiment can be ensured by setting the upper limit of conditional expression (11) to 0.90 in the optical system of the present embodiment. To further ensure the effect of the present embodiment, the upper limit of conditional expression (11) is preferably set to 0.85, more preferably to 0.80.

If the value of conditional expression (11) is below the lower limit in the optical system of the present embodiment, the refractive power of the focusing group disposed closest to the object side will become too weak, and the movement amount of the focusing group at focusing will increase, so that the overall length of the optical system will increase.

The effect of the present embodiment can be ensured by setting the lower limit of conditional expression (11) to 0.25 in the optical system of the present embodiment. To further ensure the effect of the present embodiment, the lower limit of conditional expression (11) is preferably set to 0.26, 0.28, 0.30 or 0.31, more preferably to 0.32.

In the optical system of the present embodiment, the front lens group preferably has at least one positive lens Pf satisfying the following conditional expressions.

$$1. 60 < ndPf \qquad ( 12 )$$

$$vdPf < 31. \qquad ( 13 )$$

$$0.01 < θ gFPf - ( 0.6 \; 415 - 0.00162 \times vdPf ) \qquad ( 14 )$$

where
ndPf: the refractive index at d-line of the positive lens Pf
vdPf: the Abbe number based on d-line of the positive lens Pf
θgFPf: the partial dispersion ratio of the positive lens Pf defined by the following expression:

$$θ gFPf = ( ngPf - nFPf ) / ( nFPf - nCPf )$$

where ngPf, nFPf, and nCPf denote the refractive indices of the positive lens Pf at g-line, F-line, and C-line, respectively.

The optical system of the present embodiment having at least one positive lens Pf in the front lens group can correct aberrations including axial chromatic aberration appropriately.

The optical system of the present embodiment can suppress generation of high-order aberrations by making the value of conditional expression (12) for the positive lens Pf larger than the lower limit.

The effect of the present embodiment can be ensured by setting the lower limit of conditional expression (12) to 1.60 in the optical system of the present embodiment. To further ensure the effect of the present embodiment, the lower limit of conditional expression (12) is preferably set to 1.62 or 1.64, more preferably to 1.66.

The optical system of the present embodiment can satisfactorily correct the second-order variance of the axial chromatic aberration by making the value of conditional expression (13) for the positive lens Pf smaller than the upper limit.

The effect of the present embodiment can be ensured by setting the upper limit of conditional expression (13) to 31.00 in the optical system of the present embodiment. To further ensure the effect of the present embodiment, the upper limit of conditional expression (13) is preferably set to 29.50 or 28.00, more preferably to 27.50.

The optical system of the present embodiment can satisfactorily correct the second-order variance of the axial chromatic aberration by making the value of conditional expression (14) for the positive lens Pf larger than the lower limit.

The effect of the present embodiment can be ensured by setting the lower limit of conditional expression (14) to 0.01 in the optical system of the present embodiment. To further ensure the effect of the present embodiment, the lower limit of conditional expression (14) is preferably set to 0.015 or 0.02, more preferably to 0.025.

In the optical system of the present embodiment, the front lens group preferably has at least one negative lens Nf satisfying the following conditional expressions.

$$1. 85 < ndNf \qquad ( 15 )$$

$$vdNf < 26 \text{.00} \qquad ( 16 )$$

$$θ gFNf - ( 0.6 \; 415 - 0.00162 \times vdNf ) < 0. 015 \qquad ( 17 )$$

where
ndNf: the refractive index at d-line of the negative lens Nf
vdNf: the Abbe number based on d-line of the negative lens Nf
θgFNf: the partial dispersion ratio of the negative lens Nf defined by the following expression.
   where ngNf, nFNf, and nCNf denote the refractive indices of the negative lens Nf at g-line, F-line, and C-line, respectively.

$$θ gFNf = ( ngNf - nFNf ) / ( nFNf - nCNf )$$

The optical system of the present embodiment can appropriately correct aberrations including axial chromatic aberration by having at least one negative lens Nf in the front lens group.

The optical system of the present embodiment can suppress generation of high-order aberrations by making the value of conditional expression (15) for the negative lens Nf larger than the lower limit.

The effect of the present embodiment can be ensured by setting the lower limit of conditional expression (15) to 1.85 in the optical system of the present embodiment.

The optical system of the present embodiment can satisfactorily correct the second-order variance of the axial chromatic aberration by making the value of conditional expression (16) for the negative lens Nf smaller than the upper limit.

The effect of the present embodiment can be ensured by setting the upper limit of conditional expression (16) to 26.00 in the optical system of the present embodiment. To further ensure the effect of the present embodiment, the upper limit of conditional expression (16) is preferably set to 25.80 or 25.50, more preferably to 25.20.

The optical system of the present embodiment can satisfactorily correct the second-order variance of the axial chromatic aberration by making the value of conditional expression (17) for the negative lens Nf smaller than the upper limit.

The effect of the present embodiment can be ensured by setting the upper limit of conditional expression (17) to 0.015 in the optical system of the present embodiment. To further ensure the effect of the present embodiment, the upper limit of conditional expression (17) is preferably set to 0.013 or 0.012, more preferably to 0.01.

A small-sized optical system of favorable imaging performance can be achieved by the above configurations.

The optical device of the present embodiment includes the optical system configured as described above. This enables achieving an optical device of small size and favorable optical performance.

The interchangeable lens of the present embodiment includes the optical system configured as described above. This enables achieving an interchangeable lens of small size and favorable optical performance.

The method of manufacturing an optical system of the present embodiment includes configuring an optical system including, in order from an object side, a front lens group having a positive refractive power, an aperture stop, and a rear lens group so as to satisfy the following conditional expressions.

$$0.10 < ff / \vert fr \vert < 1.5 \qquad ( 1 )$$

$$0.13 < tr / TL < 0.45 \qquad ( 2 )$$

$$0.5 < f / TL < 1.2 \qquad ( 3 )$$

where
ff: the focal length of the front lens group
fr: the focal length of the rear lens group
tr: the sum of the central thicknesses of the lenses included in the rear lens group
TL: the total length of the optical system
f: the focal length of the optical system

An optical system of small size and favorable optical performance can be manufactured by such a method for manufacturing an optical system.

### Numerical Examples

Examples of the present application will be described below with reference to the drawings.

### First Example

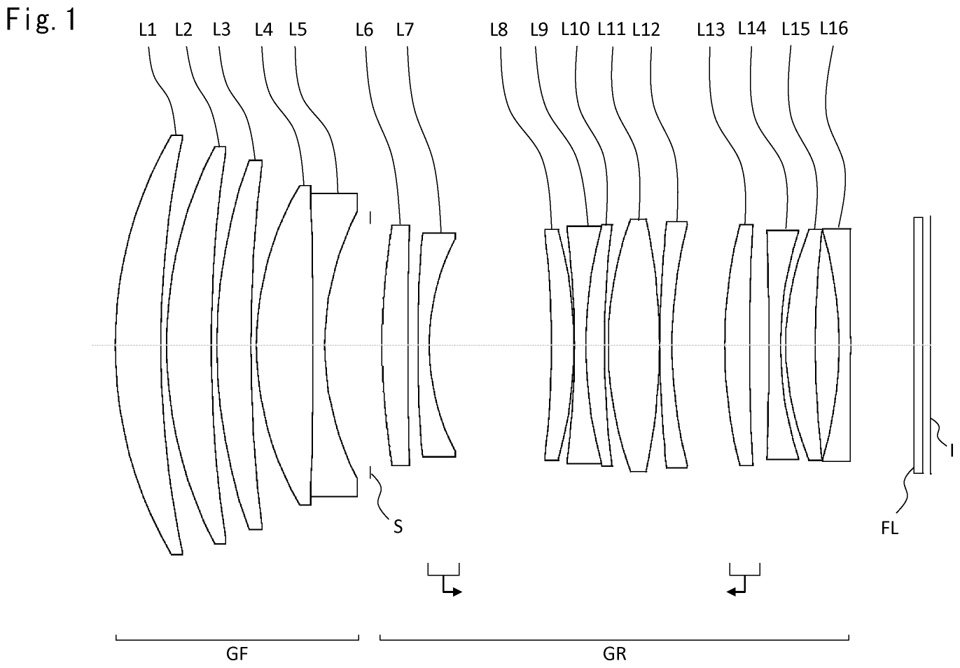

FIG. 1 is a cross-sectional view of an optical system of a first example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, an aperture stop S, and a meniscus-shaped positive lens L6 convex on the object side.

The second lens group G2 consists of a meniscus-shaped negative lens L7 convex on the object side.

The third lens group G3 consists of, in order from the object side, a meniscus-shaped positive lens L8 concave on the object side, a negative cemented lens composed of a biconcave negative lens L9 and a meniscus-shaped positive lens L10 convex on the object side, a biconvex positive lens L11, and a meniscus-shaped negative lens L12 convex on the object side.

The fourth lens group G4 consists of a meniscus-shaped positive lens L13 convex on the object side.

The fifth lens group G5 consists of, in order from the object side, a biconcave negative lens L14, a meniscus-shaped positive lens L15 convex on the object side, and a meniscus-shaped negative lens L16 concave on the object side.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side toward the image plane side, and the fourth lens group G4 moves from the image plane side to the object side.

In the optical system of the present example, the lenses from the positive lens L1 to the negative lens L5 of the first lens group G1 correspond to the front lens group, the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L11 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L16 corresponds to the lens Li1 disposed closest to the image plane side, and the positive lens L15 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 1 below shows specifications of the optical system of the present example.

In [General specifications], f is the focal length of the entire optical system; ff is the focal length of the front lens group; fr is the focal length of the rear lens group; TL is the distance from the lens surface closest to the object side to the image plane; Bf is the back focal length of the optical system in air; FNO is the F-number of the optical system; and Y is the maximum image height.

In [Lens specifications], m denotes the numbers of optical surfaces counted from the object side, r the radii of curvature, d the surface-to-surface distances, nd the refractive indices at d-line (wavelength 587.6 nm), and vd the Abbe numbers based on d-line. The radius of curvature r=∞ means a plane. In [Lens specifications], the optical surface with “*” are aspherical surfaces.

In [Aspherical surface data], m denotes the optical surfaces corresponding to the aspherical surface data, K the conic constants, and A4-A10 the aspherical coefficients. The aspheric surfaces are expressed by expression (a) below, where y denotes the height in a direction perpendicular to the optical axis, S (y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is “0”. “E-n” means “×10⁻ⁿ.”

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} \qquad ( a )$$

The unit of focal length f, radii of curvature r, and other lengths listed in Table 1 is “mm”. However, the unit is not limited thereto because the optical performance of a proportionally enlarged or reduced optical system is the same as that of the original optical system.

The above reference symbols in Table 1 will also be used similarly in the tables of the other examples described below.

TABLE 1
[General specifications]

| | |
|---|---|
| f | 132.30 |
| ff | 113.43 |
| fr | −227.10 |
| TL | 147.45 |
| Bf | 13.89 |
| FNO | 1.85 |
| Y | 21.70 |

[Lens specifications]

| m | r | d | nd | νd |
|---|---|---|---|---|
| 1) | 73.0739 | 8.2580 | 1.66382 | 27.35 |
| 2) | 173.9425 | 1.0000 | | |
| 3) | 75.0000 | 8.0959 | 1.49782 | 82.57 |
| 4) | 226.5221 | 1.0000 | | |
| 5) | 94.0000 | 6.1837 | 1.49782 | 82.57 |
| 6) | 255.7300 | 1.0000 | | |
| 7) | 55.0000 | 10.2480 | 1.49782 | 82.57 |
| 8) | −766.4853 | 2.1000 | 1.85451 | 25.15 |
| 9) | 50.0250 | 8.2444 | | |
| 10) | ∞ | 2.1000 | | (aperture stop) |
| *11) | 105.9598 | 4.7000 | 1.51680 | 64.14 |
| 12) | 853.5480 | D12 | | |
| 13) | 221.6993 | 2.1000 | 1.69680 | 55.52 |
| 14) | 39.4223 | D14 | | |
| 15) | −164.4380 | 4.0545 | 1.80809 | 22.74 |
| 16) | −75.4132 | 0.1000 | | |
| 17) | −160.7346 | 2.1000 | 1.85451 | 25.15 |
| 18) | 80.4120 | 3.2958 | 1.59319 | 67.90 |
| 19) | 157.8647 | 0.7213 | | |
| 20) | 64.0655 | 9.2661 | 1.80440 | 39.61 |
| 21) | −101.7863 | 0.1000 | | |
| 22) | 195.9905 | 2.2000 | 1.83481 | 42.73 |
| 23) | 83.1844 | D23 | | |
| 24) | 85.1050 | 4.4549 | 1.85883 | 30.00 |
| 25) | 380.6074 | D25 | | |
| 26) | −542.5119 | 2.1000 | 1.78590 | 44.17 |
| 27) | 62.2755 | 1.0000 | | |
| 28) | 51.4253 | 5.3074 | 1.84666 | 23.78 |
| 29) | 162.7875 | 4.3017 | | |
| 30) | −70.4474 | 2.1000 | 1.81600 | 46.59 |
| 31) | −2372.9554 | 11.4681 | | |
| 32) | ∞ | 1.6000 | 1.51680 | 64.14 |
| 33) | ∞ | 1.3712 | | |

[Aspherical surface data]

| m | K | A4 | A6 | A8 | A10 |
|---|---|---|---|---|---|
| 11) | 1.0000 | −1.741E−06 | −1.130E−10 | −2.868E−14 | 9.211E−17 |

[Focal length data of groups]

| Groups | First surfaces | Focal lengths |
|---|---|---|
| G1 | 1 | 89.30 |
| G2 | 13 | −69.14 |
| G3 | 15 | 116.43 |
| G4 | 24 | 126.75 |
| G5 | 26 | −71.11 |

[Variable spacing data]

| | At focusing on infinity | At focusing nearby |
|---|---|---|
| D12 | 1.749 | 15.346 |
| D14 | 22.105 | 8.507 |
| D23 | 9.528 | 3.345 |
| D25 | 3.500 | 9.684 |

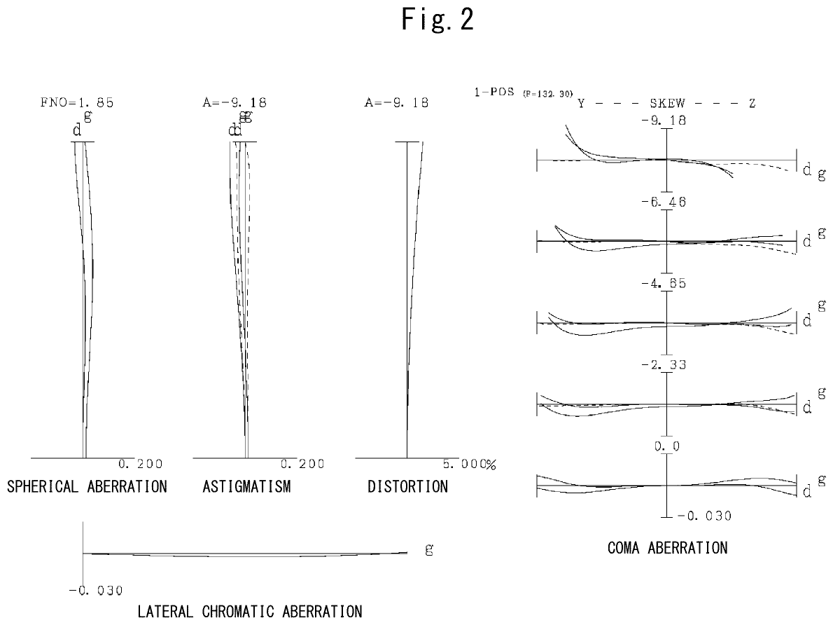

FIG. 2 shows aberrations of the optical system of the first example.

In the graphs of aberrations, FNO and A denote f-number and image height, respectively. More specifically, the graph of spherical aberration shows the f-number corresponding to the maximum aperture, the graphs of astigmatism and distortion show the maximum of image height, and the graphs of coma aberration show the values of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the optical system of the present example corrects aberrations appropriately and has high optical performance.

### Second Example

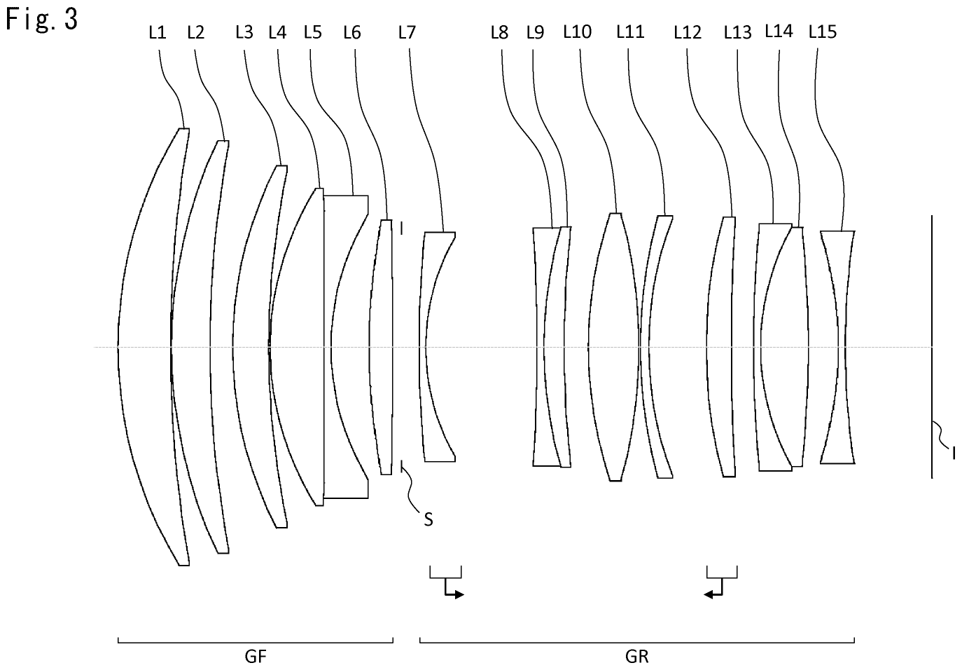

FIG. 3 is a cross-sectional view of an optical system of a second example focusing on an object at infinity.

The optical system of present example includes, in order from the object side, a first lens group G1 having a positive refractive power, an aperture stop S, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, and a biconvex positive lens L6.

The second lens group G2 consists of a meniscus-shaped negative lens L7convex on the object side.

The third lens group G3 consists of, in order from the object side, a negative cemented lens composed of a biconcave negative lens L8 and a meniscus-shaped positive lens L9 convex on the object side, a biconvex positive lens L10, and a meniscus-shaped negative lens L11 convex on the object side.

The fourth lens group G4 consists of a meniscus-shaped positive lens L12convex on the object side.

The fifth lens group G5 consists of, in order from the object side, a positive cemented lens composed of a meniscus-shaped negative lens L13 convex on the object side and a biconvex positive lens L14, and a biconcave negative lens L15.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the first lens group G1 corresponds to the front lens group, and the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group G5 corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the positive lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 2 below shows specifications of the optical system of the present example.

TABLE 2
[General specifications]

| | |
|---|---|
| f | 132.30 |
| ff | 84.98 |
| fr | −99.98 |
| TL | 144.99 |
| Bf | 15.36 |
| FNO | 1.85 |
| Y | 21.70 |

[Lens specifications]

| m | r | d | nd | νd |
|---|---|---|---|---|
| 1) | 71.4223 | 9.3392 | 1.66382 | 27.35 |
| 2) | 212.8546 | 0.2000 | | |
| 3) | 82.3011 | 6.8153 | 1.49782 | 82.57 |
| 4) | 189.8030 | 4.0179 | | |
| 5) | 67.8053 | 6.4147 | 1.49782 | 82.57 |
| 6) | 146.3981 | 0.2000 | | |
| 7) | 50.4121 | 9.6499 | 1.49782 | 82.57 |
| 8) | −3183.7228 | 1.2000 | 1.85451 | 25.15 |
| 9) | 43.4640 | 6.7260 | | |
| *10) | 98.1806 | 4.1632 | 1.51680 | 64.14 |
| 11) | −1338.1241 | 1.6925 | | |
| 12) | ∞ | D12 | | (aperture stop) |
| 13) | 187.4183 | 1.2000 | 1.69680 | 55.52 |
| 14) | 37.4569 | D14 | | |
| 15) | −331.5883 | 1.2000 | 1.84666 | 23.80 |
| 16) | 72.4584 | 3.6449 | 1.59319 | 67.90 |
| 17) | 187.4042 | 4.2922 | | |
| 18) | 72.7147 | 9.0000 | 1.68376 | 37.64 |
| 19) | −83.4441 | 0.2000 | | |
| 20) | 85.5767 | 1.5000 | 2.00069 | 25.46 |
| 21) | 60.8156 | D21 | | |
| 22) | 85.9402 | 4.5000 | 1.95000 | 29.37 |
| 23) | 390.8660 | D23 | | |
| 24) | 229.3158 | 1.2000 | 1.88300 | 40.69 |
| 25) | 41.6420 | 8.5000 | 1.85451 | 25.15 |
| 26) | −188.3950 | 5.3350 | | |
| *27) | −58.0337 | 1.2000 | 1.79526 | 45.25 |
| 28) | 127.2294 | D28 | | |
| 29) | ∞ | 1.6000 | 1.51680 | 63.88 |
| 30) | ∞ | 1.0000 | | |

[Aspherical surface data]

| m | K | A4 | A6 | A8 | A10 |
|---|---|---|---|---|---|
| 10) | 1.0000 | −1.415E−06 | 1.034E−10 | −6.229E−13 | 6.524E−16 |
| 27) | 1.0000 | 2.317E−06 | 2.412E−10 | −4.722E−12 | 5.079E−15 |

[Focal length data of groups]

| Groups | First surfaces | Focal lengths |
|---|---|---|
| G1 | 1 | 84.98 |
| G2 | 13 | −67.40 |
| G3 | 15 | 220.38 |
| G4 | 22 | 115.13 |
| G5 | 24 | −89.30 |

[Variable spacing data]

| | At focusing on infinity | At focusing nearby |
|---|---|---|
| D12 | 3.000 | 15.000 |
| D14 | 19.761 | 7.761 |
| D21 | 10.199 | 3.077 |
| D23 | 3.934 | 11.057 |
| D28 | 13.303 | 13.340 |

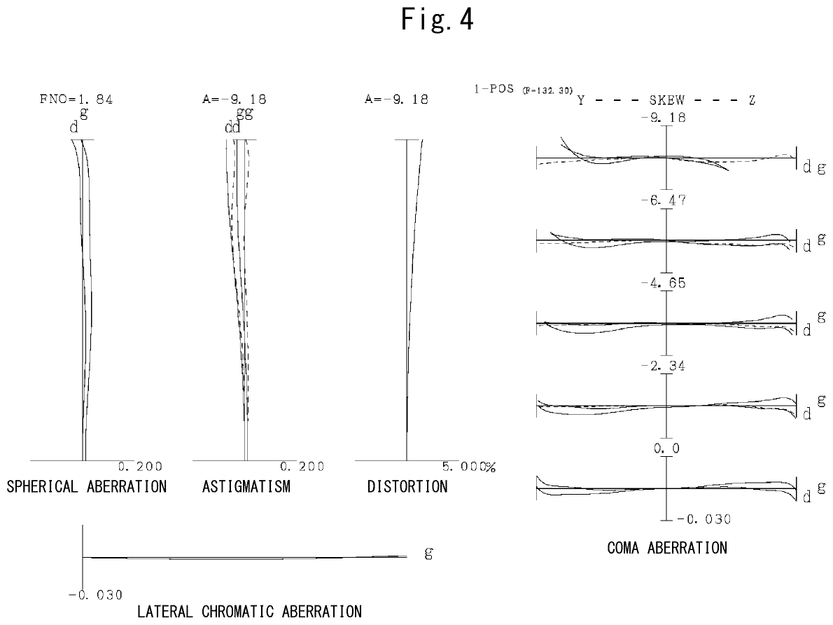

FIG. 4 is aberration diagrams of the optical system of the second example.

The graphs of aberrations suggest that the optical system of the present example corrects aberrations appropriately and has high optical performance.

### Third Example

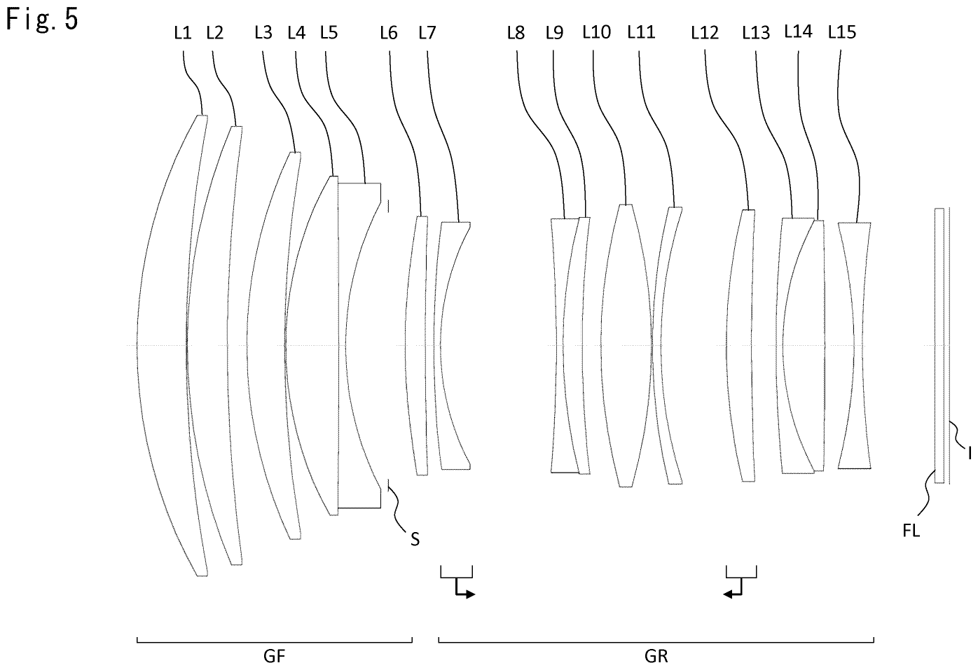

FIG. 5 is a cross-sectional view of an optical system of a third example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, an aperture stop S, and a meniscus-shaped positive lens L6 convex on the object side.

The second lens group G2 consists of a meniscus-shaped negative lens L7 convex on the object side.

The third lens group G3 consists of, in order from the object side, a negative cemented lens composed of a biconcave negative lens L8 and a meniscus-shaped positive lens L9 convex on the object side, a biconvex positive lens L10, and a meniscus-shaped negative lens L11 convex on the object side.

The fourth lens group G4 consists of a meniscus-shaped positive lens L12 convex on the object side.

The fifth lens group G5 consists of, in order from the object side, a positive cemented lens composed of a meniscus-shaped negative lens L13 convex on the object side and a biconvex positive lens L14, and a biconcave negative lens L15.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the lenses from the positive lens L1 to the negative lens L5 of the first lens group G1 correspond to the front lens group, and the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the positive lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 3 below shows specifications of the optical system of the present example.

TABLE 3
[General specifications]

| | |
|---|---|
| f | 132.30 |
| ff | 112.47 |
| fr | −196.89 |
| TL | 145.00 |
| Bf | 15.00 |
| FNO | 1.84 |
| Y | 21.70 |

[Lens specifications]

| m | r | d | nd | νd |
|---|---|---|---|---|
| 1) | 71.7601 | 8.8107 | 1.66382 | 27.35 |
| 2) | 184.7948 | 0.2000 | | |
| 3) | 86.2502 | 7.1330 | 1.49782 | 82.57 |
| 4) | 237.5854 | 3.4700 | | |
| 5) | 69.0966 | 6.7579 | 1.49782 | 82.57 |
| 6) | 167.1912 | 0.2000 | | |
| 7) | 53.2464 | 9.4720 | 1.49782 | 82.57 |
| 8) | −1820.1966 | 1.2000 | 1.85451 | 25.15 |
| 9) | 47.3137 | 7.6169 | | |
| 10) | ∞ | 3.0000 | | (aperture stop) |
| 11) | 92.4608 | 3.6037 | 1.51680 | 64.14 |
| 12) | 557.2232 | D12 | | |
| 13) | 146.6010 | 1.2000 | 1.69680 | 55.52 |
| 14) | 38.6158 | D14 | | |
| 15) | −234.1612 | 1.2000 | 1.85451 | 25.15 |
| 16) | 77.2640 | 3.4308 | 1.59319 | 67.90 |
| 17) | 165.0443 | 3.3299 | | |
| 18) | 82.1496 | 9.0000 | 1.73800 | 32.33 |
| 19) | −78.9827 | 0.2000 | | |
| 20) | 90.3107 | 1.5000 | 1.90200 | 25.26 |
| 21) | 67.5653 | D21 | | |
| 22) | 87.9013 | 4.5000 | 1.83481 | 42.73 |
| 23) | 437.5569 | D23 | | |
| 24) | 191.2552 | 1.2000 | 1.88300 | 40.69 |
| 25) | 40.4406 | 7.5029 | 1.85451 | 25.15 |
| 26) | −998.5745 | 5.2026 | | |
| 27) | −66.7707 | 1.5000 | 1.79526 | 45.25 |
| 28) | 135.3380 | D28 | | |
| 29) | ∞ | 1.6000 | 1.51680 | 63.88 |
| 30) | ∞ | 1.0000 | | |

[Aspherical surface data]

| m | K | A4 | A6 | A8 | A10 |
|---|---|---|---|---|---|
| 11) | 1.0000 | −1.618E−06 | 1.005E−10 | −9.102E−13 | 1.027E−15 |
| 27) | 1.0000 | 1.794E−06 | 3.511E−10 | −4.194E−12 | 4.714E−15 |

[Focal length data of groups]

| Groups | First surfaces | Focal lengths |
|---|---|---|
| G1 | 1 | 87.05 |
| G2 | 13 | −75.58 |
| G3 | 15 | 188.31 |
| G4 | 22 | 131.00 |
| G5 | 24 | −81.36 |

[Variable spacing data]

| | At focusing on infinity | At focusing nearby |
|---|---|---|
| D12 | 1.500 | 14.150 |
| D14 | 20.677 | 8.026 |
| D21 | 11.687 | 2.799 |
| D23 | 4.359 | 13.247 |
| D28 | 12.949 | 12.967 |

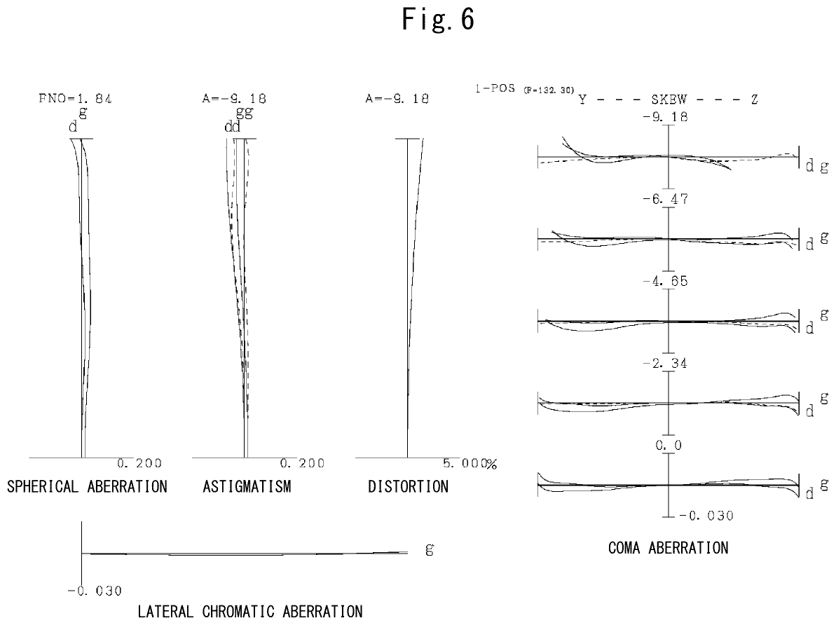

FIG. 6 shows aberrations of the optical system of the third example.

The graphs of aberrations suggest that the optical system of the present example corrects aberrations appropriately and has high optical performance.

### Fourth Example

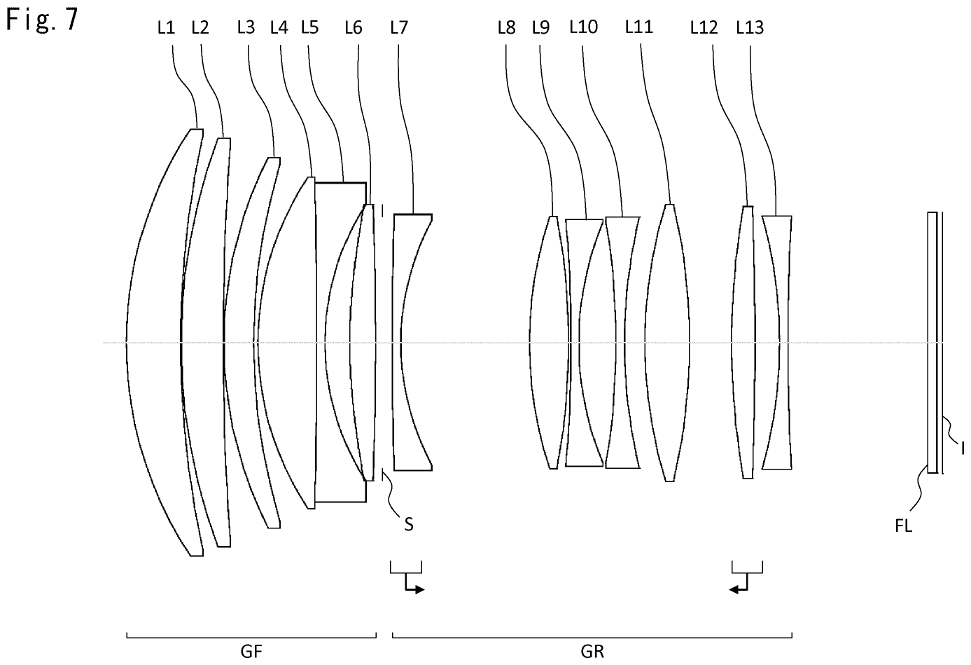

FIG. 7 is a cross-sectional view of an optical system of a fourth example focusing on an object at infinity.

The optical system of present example includes, in order from the object side, a first lens group G1 having a positive refractive power, an aperture stop S, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, and a biconvex positive lens L6.

The second lens group G2 consists of a meniscus-shaped negative lens L7 convex on the object side.

The third lens group G3 consists of, in order from the object side, a biconvex positive lens L8, a biconcave negative lens L9, a biconcave negative lens L10, and a biconvex positive lens L11.

The fourth lens group G4 consists of a biconvex positive lens L12.

The fifth lens group G5 consists of a biconcave negative lens L13.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the first lens group G1 corresponds to the front lens group, and the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L11 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L13 corresponds to the lens Li1 disposed closest to the image plane side, and the positive lens L12 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 4 below shows specifications of the optical system of the present example.

TABLE 4
[General specifications]

| | |
|---|---|
| f | 132.50 |
| ff | 89.44 |
| fr | −275.65 |
| TL | 145.93 |
| Bf | 27.06 |
| FNO | 1.84 |
| Y | 21.70 |

[Lens specifications]

| m | r | d | nd | νd |
|---|---|---|---|---|
| 1) | 66.3183 | 9.7104 | 1.66382 | 27.35 |
| 2) | 165.2220 | 0.1000 | | |
| 3) | 100.0420 | 7.5397 | 1.43700 | 95.00 |
| 4) | 483.6760 | 0.1000 | | |
| 5) | 69.7432 | 5.3124 | 1.48749 | 70.24 |
| 6) | 105.3980 | 0.7647 | | |
| 7) | 51.1334 | 10.4840 | 1.55032 | 75.49 |
| 8) | −1410.8700 | 1.4999 | 1.85478 | 24.80 |
| 9) | 43.2806 | 4.4516 | | |
| *10) | 96.9716 | 4.5988 | 1.49782 | 82.56 |
| 11) | −620.9090 | 1.1187 | | |
| 12) | ∞ | D12 | | (aperture stop) |
| 13) | 758.4980 | 1.4999 | 1.59319 | 67.87 |
| 14) | 43.6263 | D14 | | |
| 15) | 69.5215 | 6.9627 | 1.83400 | 37.18 |
| 16) | −117.7280 | 0.4462 | | |
| 17) | −249.8720 | 1.4000 | 1.71736 | 29.57 |
| 18) | 53.3330 | 6.6458 | | |
| 19) | −124.6990 | 1.5000 | 1.66446 | 35.86 |
| 20) | 89.4859 | 3.6246 | | |
| 21) | 78.8983 | 8.0487 | 1.85026 | 32.35 |
| 22) | −100.9890 | D22 | | |
| 23) | 132.3330 | 4.1642 | 1.90200 | 25.26 |
| 24) | −628.5160 | D24 | | |
| 25) | −80.5301 | 1.5000 | 1.85026 | 32.35 |
| 26) | 378.0000 | 25.0012 | | |
| 27) | ∞ | 1.6000 | 1.51680 | 63.80 |
| 28) | ∞ | 1.0013 | | |

[Aspherical surface data]

| m | K | A4 | A6 | A8 | A10 |
|---|---|---|---|---|---|
| 10) | 1.0000 | −1.352E−06 | −3.019E−10 | −2.040E−14 | 0.000E+00 |

[Focal length data of groups]

| Groups | First surfaces | Focal lengths |
|---|---|---|
| G1 | 1 | 89.44 |
| G2 | 13 | −78.09 |
| G3 | 15 | 101.43 |
| G4 | 23 | 121.51 |
| G5 | 25 | −77.96 |

[Variable spacing data]

| | At focusing on infinity | At focusing nearby |
|---|---|---|
| D12 | 1.900 | 15.168 |
| D14 | 23.030 | 9.761 |
| D22 | 7.512 | 3.134 |
| D24 | 4.409 | 8.787 |

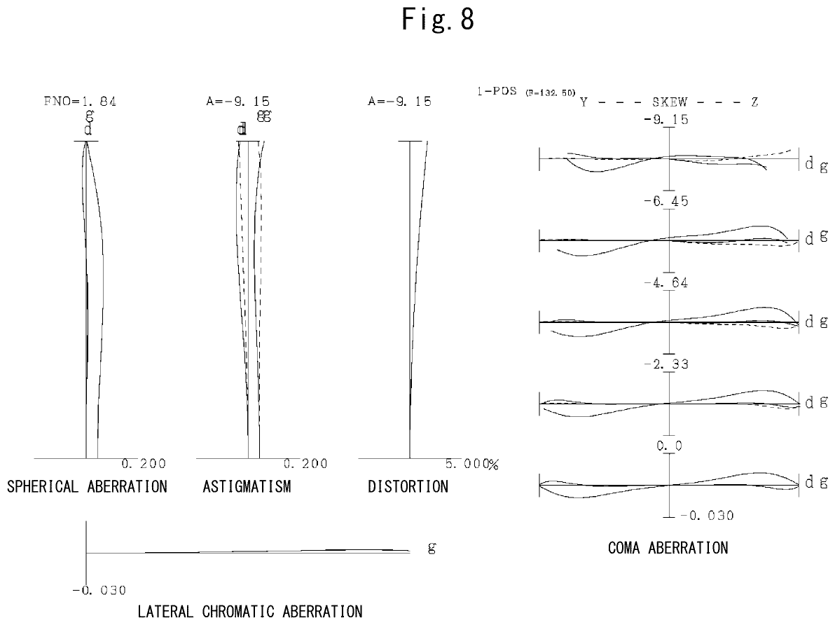

FIG. 8 shows aberrations of the optical system of the fourth example.

The graphs of aberrations suggest that the optical system of the present example corrects aberrations appropriately and has high optical performance.

### Fifth Example

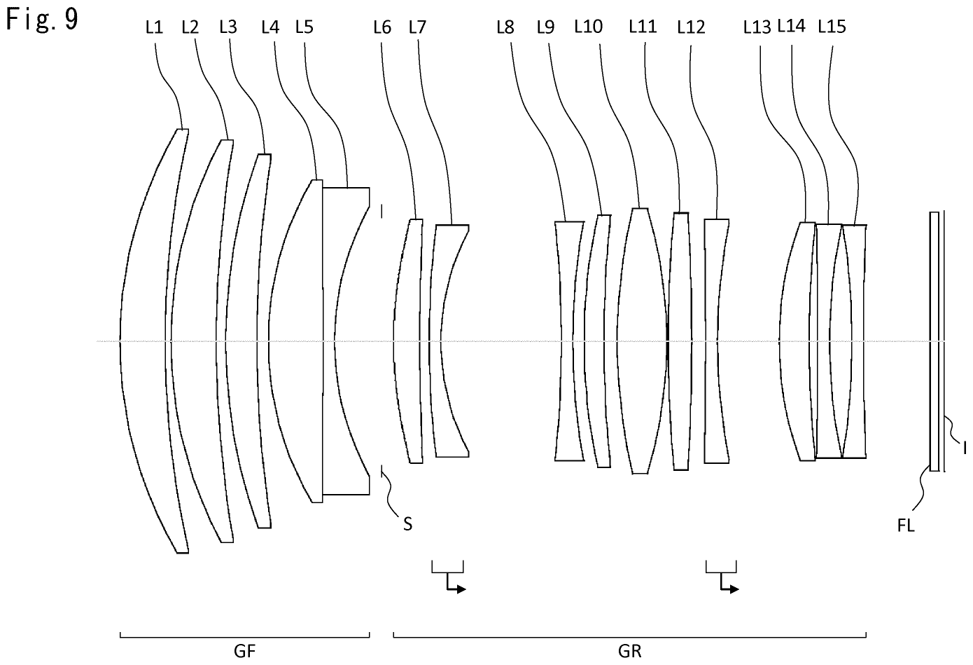

FIG. 9 is a cross-sectional view of an optical system of a fifth example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a negative refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, an aperture stop S, and a meniscus-shaped positive lens L6 convex on the object side.

The second lens group G2 consists of a meniscus-shaped negative lens L7 convex on the object side.

The third lens group G3 consists of, in order from the object side, a biconcave negative lens L8, a meniscus-shaped positive lens L9 convex on the object side, a biconvex positive lens L10, and a biconvex positive lens L11.

The fourth lens group G4 consists of a biconcave negative lens L12.

The fifth lens group G5 consists of, in order from the object side, a meniscus-shaped positive lens L13 convex on the object side, a biconcave negative lens L14, and a biconcave negative lens L15.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 and the fourth lens group G4 move from the object side to the image plane side in different trajectories.

In the optical system of the present example, the lenses from the positive lens L1 to the negative lens L5 of the first lens group G1 correspond to the front lens group, and the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the positive lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 5 below shows specifications of the optical system of the present example.

TABLE 5
[General specifications]

| | |
|---|---|
| f | 132.30 |
| ff | 127.35 |
| fr | −496.37 |
| TL | 147.53 |
| Bf | 13.91 |
| FNO | 1.85 |
| Y | 21.70 |

[Lens specifications]

| m | r | d | nd | νd |
|---|---|---|---|---|
| 1) | 72.0000 | 8.1143 | 1.66382 | 27.35 |
| 2) | 161.8404 | 1.0002 | | |
| 3) | 72.6315 | 8.1310 | 1.49782 | 82.57 |
| 4) | 199.5442 | 1.6725 | | |
| 5) | 94.0000 | 5.5489 | 1.49782 | 82.57 |
| 6) | 202.8688 | 2.1185 | | |
| 7) | 55.0000 | 9.7215 | 1.49782 | 82.57 |
| 8) | −4288.4061 | 2.1000 | 1.85451 | 25.15 |
| 9) | 48.0031 | 8.4369 | | |
| 10) | ∞ | 2.1000 | | (aperture stop) |
| *11) | 68.5824 | 4.7000 | 1.51680 | 64.13 |
| 12) | 441.6203 | D12 | | |
| 13) | 157.7474 | 2.1000 | 1.72916 | 54.61 |
| 14) | 39.7106 | D14 | | |
| 15) | −202.1129 | 2.1000 | 1.85451 | 25.15 |
| 16) | 112.5075 | 2.0137 | | |
| 17) | 100.0000 | 3.5631 | 1.59319 | 67.90 |
| 18) | 208.1606 | 2.3956 | | |
| 19) | 100.0000 | 8.8106 | 1.76200 | 40.11 |
| 20) | −79.7795 | 0.2910 | | |
| 21) | 250.6999 | 4.1838 | 1.86074 | 23.08 |
| 22) | −393.9542 | D22 | | |
| 23) | −1082.0011 | 2.1000 | 1.60738 | 56.74 |
| 24) | 100.0000 | D24 | | |
| 25) | 59.1913 | 5.3939 | 1.86074 | 23.08 |
| 26) | 207.0827 | 1.5307 | | |
| 27) | −899.4731 | 2.1000 | 1.80400 | 46.60 |
| 28) | 95.4791 | 3.9878 | | |
| 29) | −123.4835 | 2.1000 | 1.86074 | 23.08 |
| 30) | 594.5786 | 11.8530 | | |
| 31) | ∞ | 1.6000 | 1.51680 | 63.88 |
| 32) | ∞ | 1.0000 | | |

[Aspherical surface data]

| m | K | A4 | A6 | A8 | A10 |
|---|---|---|---|---|---|
| 11) | 1.0000 | −1.726E−06 | −4.489E−10 | −1.063E−13 | −9.041E−17 |

[Focal length data of groups]

| Groups | First surfaces | Focal lengths |
|---|---|---|
| G1 | 1 | 87.22 |
| G2 | 13 | −73.33 |
| G3 | 15 | 64.71 |
| G4 | 23 | −150.61 |
| G5 | 25 | −169.73 |

[Variable spacing data]

| | At focusing on infinity | At focusing nearby |
|---|---|---|
| D12 | 1.671 | 15.261 |
| D14 | 21.508 | 7.918 |
| D22 | 2.500 | 10.558 |
| D24 | 1.058 | 3.000 |

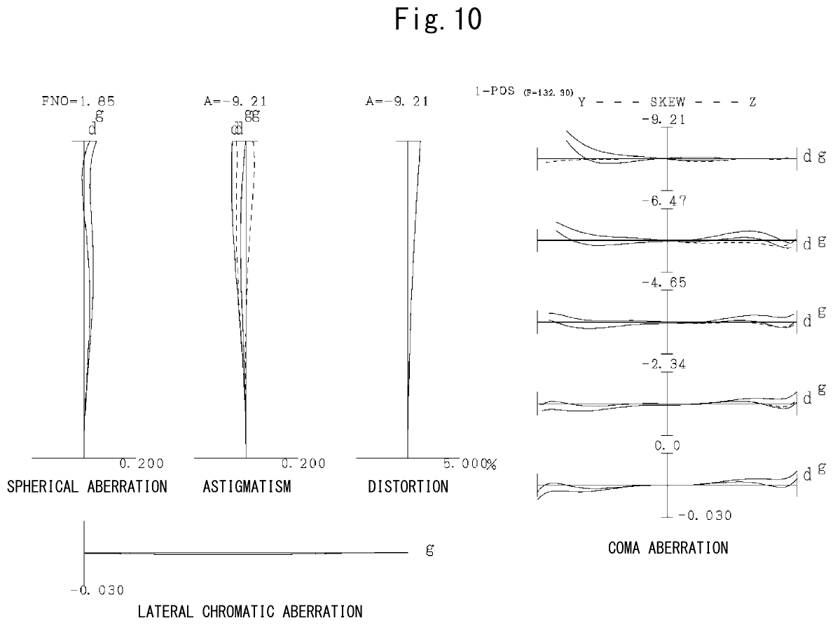

FIG. 10 shows aberrations of the optical system of the fifth example.

The graphs of aberrations suggest that the optical system of the present example corrects aberrations appropriately and has high optical performance.

### Sixth Example

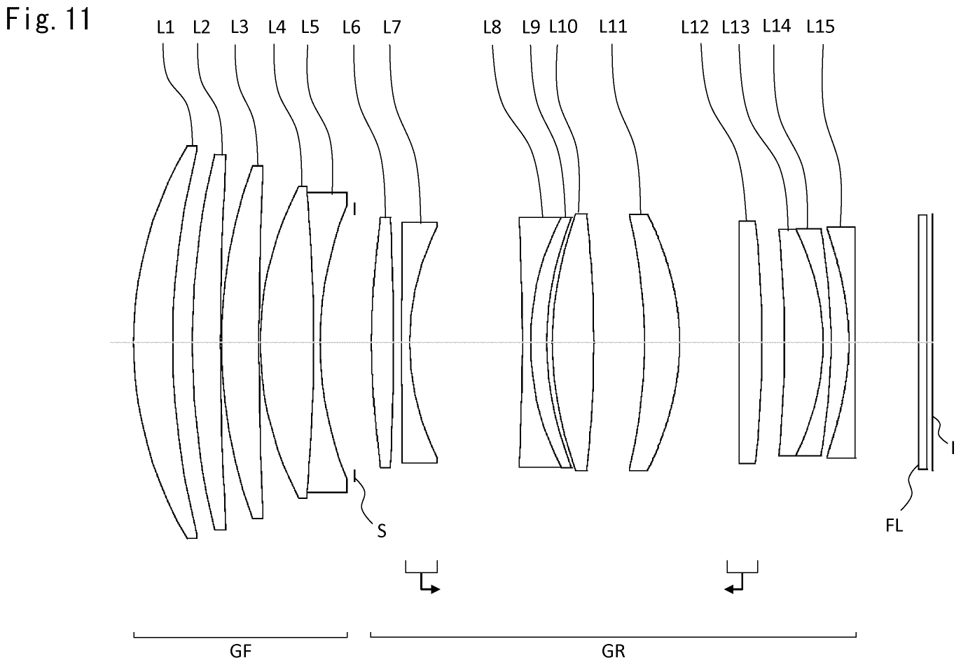

FIG. 11 is a cross-sectional view of an optical system of a sixth example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, an aperture stop S, and a biconvex positive lens L6.

The second lens group G2 consists of a meniscus-shaped negative lens L7 convex on the object side.

The third lens group G3 consists of, in order from the object side, a negative cemented lens composed of a biconcave negative lens L8 and a meniscus-shaped positive lens L9 convex on the object side, a biconvex positive lens L10, and a meniscus-shaped positive lens L11 concave on the object side.

The fourth lens group G4 consists of a planoconvex positive lens L12 plane on the object side.

The fifth lens group G5 consists of, in order from the object side, a positive cemented lens composed of a meniscus-shaped positive lens L13 concave on the object side and a meniscus-shaped negative lens L14 concave on the object side, and a planoconcave negative lens L15 concave on the object side.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the lenses from the positive lens L1 to the negative lens L5 of the first lens group G1 correspond to the front lens group, and the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the negative lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 6 below shows specifications of the optical system of the present example.

TABLE 6
[General specifications]

| | |
|---|---|
| f | 122.20 |
| ff | 112.14 |
| fr | −177.50 |
| TL | 145.00 |
| Bf | 13.45 |
| FNO | 1.85 |
| Y | 21.70 |

[Lens specifications]

| m | r | d | nd | νd |
|---|---|---|---|---|
| 1) | 66.9113 | 7.1102 | 1.66382 | 27.35 |
| 2) | 132.6147 | 3.5669 | | |
| 3) | 137.4634 | 5.1224 | 1.49782 | 82.57 |
| 4) | 540.1386 | 0.2000 | | |
| 5) | 89.9080 | 6.7766 | 1.49782 | 82.57 |
| 6) | 613.1016 | 0.2000 | | |
| 7) | 57.3140 | 9.6789 | 1.49782 | 82.57 |
| 8) | −307.5506 | 1.2000 | 1.85451 | 25.15 |
| 9) | 63.0143 | 6.3078 | | |
| 10) | ∞ | 3.0000 | | (aperture stop) |
| *11) | 122.2242 | 4.0000 | 1.51680 | 64.13 |
| 12) | −458.5930 | D12 | | |
| 13) | 4486.7234 | 1.5000 | 1.59349 | 67.00 |
| 14) | 44.8020 | D14 | | |
| 15) | −430.0623 | 1.5000 | 1.85451 | 25.15 |
| 16) | 47.1972 | 2.9853 | 2.00100 | 29.12 |
| 17) | 57.6854 | 1.0000 | | |
| 18) | 63.0295 | 7.5095 | 2.00069 | 25.46 |
| 19) | −194.4050 | 9.1686 | | |
| 20) | −93.7633 | 6.3889 | 1.61800 | 63.34 |
| *21) | −43.5220 | D21 | | |
| 22) | ∞ | 4.1055 | 1.72047 | 34.71 |
| 23) | −206.0663 | D23 | | |
| 24 | −192.6542 | 6.9552 | 1.80518 | 25.45 |
| 25) | −43.3466 | 1.4653 | 2.00069 | 25.46 |
| 26) | −110.3893 | 3.2612 | | |
| *27) | −43.8980 | 1.2000 | 1.79526 | 45.25 |
| 28) | ∞ | 11.3953 | | |
| 29) | ∞ | 1.6000 | 1.51680 | 64.13 |
| 30) | ∞ | 1.0001 | | |

[Aspherical surface data]

| m | K | A4 | A6 | A8 | A10 |
|---|---|---|---|---|---|
| 11) | 1.0000 | −1.521E−06 | −1.713E−10 | −2.725E−13 | 3.136E−16 |
| 21) | 1.0000 | 2.328E−06 | −8.987E−10 | 7.838E−13 | −1.151E−16 |
| 27) | 1.0000 | 7.505E−06 | −5.432E−09 | −6.999E−13 | 5.724E−15 |

[Focal length data of groups]

| Groups | First surfaces | Focal lengths |
|---|---|---|
| G1 | 1 | 81.65 |
| G2 | 13 | −76.26 |
| G3 | 15 | 79.48 |
| G4 | 22 | 286.02 |
| G5 | 24 | −55.59 |

[Variable spacing data]

| | At focusing on infinity | At focusing nearby |
|---|---|---|
| D12 | 1.500 | 14.388 |
| D14 | 20.384 | 7.496 |
| D21 | 10.795 | 1.806 |
| D23 | 4.123 | 13.113 |

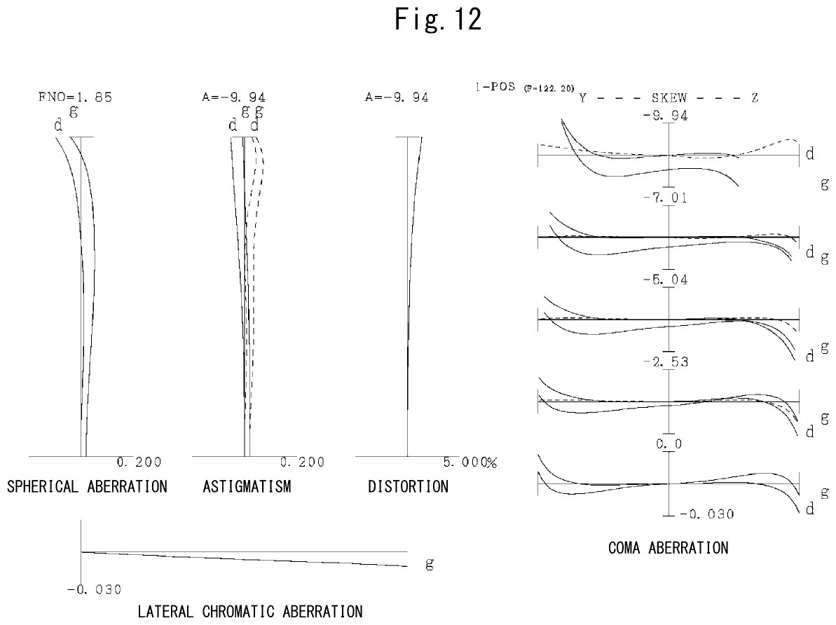

FIG. 12 shows aberrations of the optical system of the sixth example.

The graphs of aberrations suggest that the optical system of the present example corrects aberrations appropriately and has high optical performance.

### Seventh Example

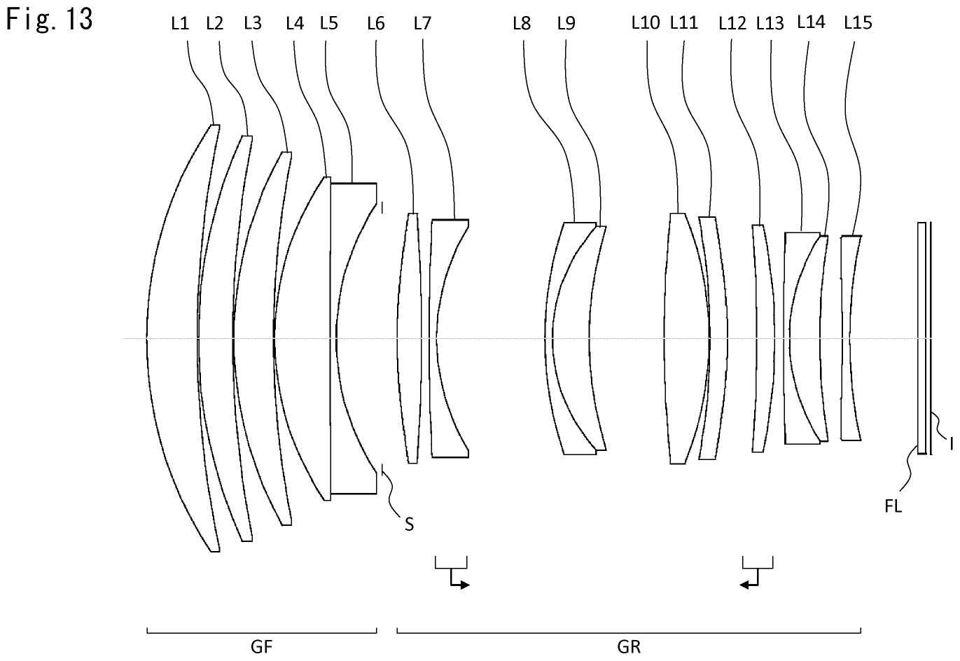

FIG. 13 is a cross-sectional view of an optical system of a seventh example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a meniscus-shaped positive lens L4 convex on the object side and a meniscus-shaped negative lens L5 convex on the object side, an aperture stop S, and a biconvex positive lens L6.

The second lens group G2 consists of a meniscus-shaped negative lens L7 convex on the object side.

The third lens group G3 consists of, in order from the object side, a negative cemented lens composed of a meniscus-shaped negative lens L8 convex on the object side and a meniscus-shaped positive lens L9 convex on the object side, a biconvex positive lens L10, and a meniscus-shaped positive lens L11 concave on the object side.

The fourth lens group G4 consists of a meniscus-shaped positive lens L12 concave on the object side.

The fifth lens group G5 consists of, in order from the object side, a negative cemented lens composed of a meniscus-shaped negative lens L13 convex on the object side and a meniscus-shaped positive lens L14 convex on the object side, and a biconcave negative lens L15.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the lenses from the positive lens L1 to the negative lens L5 of the first lens group G1 correspond to the front lens group, and the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the positive lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 7 below shows specifications of the optical system of the present example.

TABLE 7
[General specifications]

| | |
|---|---|
| f | 147.00 |
| ff | 129.17 |
| fr | −189.05 |
| TL | 157.00 |
| Bf | 15.74 |
| FNO | 1.85 |
| Y | 21.70 |

[Lens specifications]

| m | r | d | nd | νd |
|---|---|---|---|---|
| 1) | 74.1751 | 10.1607 | 1.66382 | 27.35 |
| 2) | 191.7895 | 0.2000 | | |
| 3) | 93.9587 | 6.9178 | 1.49782 | 82.57 |
| 4) | 200.7834 | 0.2000 | | |
| 5) | 74.0198 | 7.9191 | 1.49782 | 82.57 |
| 6) | 179.5298 | 0.2000 | | |
| 7) | 55.0947 | 11.1364 | 1.49782 | 82.57 |
| 8) | 3267.0580 | 1.2000 | 1.85451 | 25.15 |
| 9) | 47.1440 | 9.1892 | | |
| 10) | ∞ | 3.0000 | | |
| *11) | 106.1518 | 4.9153 | 1.51680 | 64.13 |
| 12) | −333.2392 | D12 | | |
| 13) | 447.5810 | 1.5000 | 1.59349 | 67.00 |
| 14) | 40.6656 | D14 | | |
| 15) | 68.0477 | 1.5000 | 1.90366 | 31.27 |
| 16) | 31.3982 | 7.3704 | 1.59319 | 67.90 |
| 17) | 70.6986 | 14.9835 | | |
| 18) | 230.0945 | 9.0000 | 1.90366 | 31.27 |
| 19) | −63.8675 | 0.2000 | | |
| 20) | −125.7886 | 3.5000 | 1.51680 | 64.13 |
| *21) | −83.8591 | D21 | | |
| 22) | −283.7511 | 3.5722 | 1.69895 | 30.13 |
| 23) | −110.1588 | D23 | | |
| 24) | 522.5170 | 1.2000 | 1.88300 | 40.69 |
| 25) | 36.0701 | 6.0890 | 1.68893 | 31.16 |
| 26) | 121.3136 | 4.4693 | | |
| *27) | −217.7830 | 1.5000 | 1.85108 | 40.12 |
| 28) | 91.8799 | 13.6807 | | |
| 29) | ∞ | 1.6000 | 1.51680 | 64.13 |
| 30) | ∞ | 1.0000 | | |

[Aspherical surface data]

| m | K | A4 | A6 | A8 | A10 |
|---|---|---|---|---|---|
| 11) | 1.0000 | −1.573E−06 | −1.204E−10 | −1.440E−13 | 2.081E−16 |
| 21) | 1.0000 | 4.670E−06 | −4.131E−09 | 3.245E−12 | −2.590E−15 |
| 27) | 1.0000 | 7.294E−06 | −1.088E−08 | 1.539E−11 | −1.356E−14 |

[Focal length data of groups]

| Groups | First surfaces | Focal lengths |
|---|---|---|
| G1 | 1 | 88.53 |
| G2 | 13 | −75.47 |
| G3 | 15 | 61.62 |
| G4 | 22 | 255.46 |
| G5 | 24 | −42.70 |

[Variable spacing data]

| | At focusing on infinity | At focusing nearby |
|---|---|---|
| D12 | 1.500 | 15.236 |
| D14 | 21.671 | 7.935 |
| D21 | 5.840 | 1.300 |
| D23 | 1.786 | 6.327 |

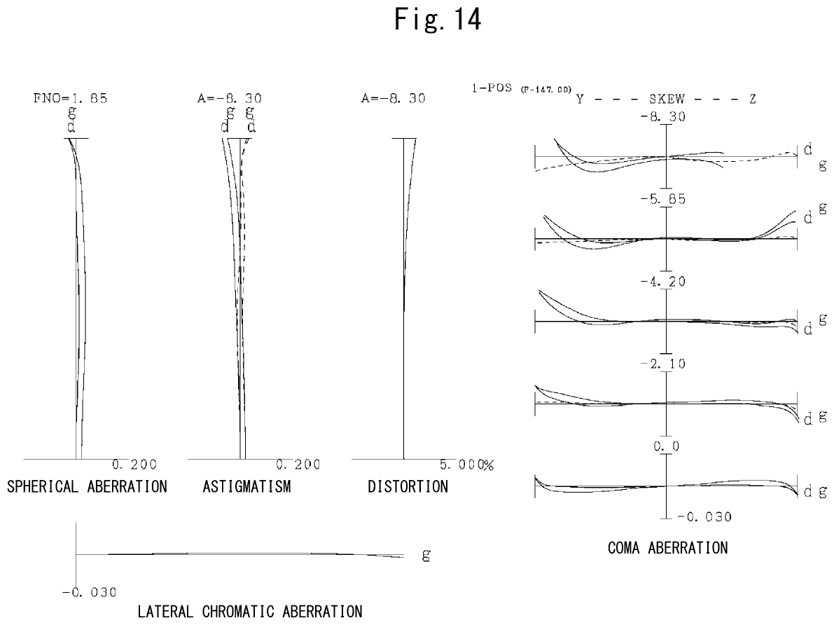

FIG. 14 shows aberrations of the optical system of the seventh example.

The graphs of aberrations suggest that the optical system of the present example corrects aberrations appropriately and has high optical performance.

### Eighth Example

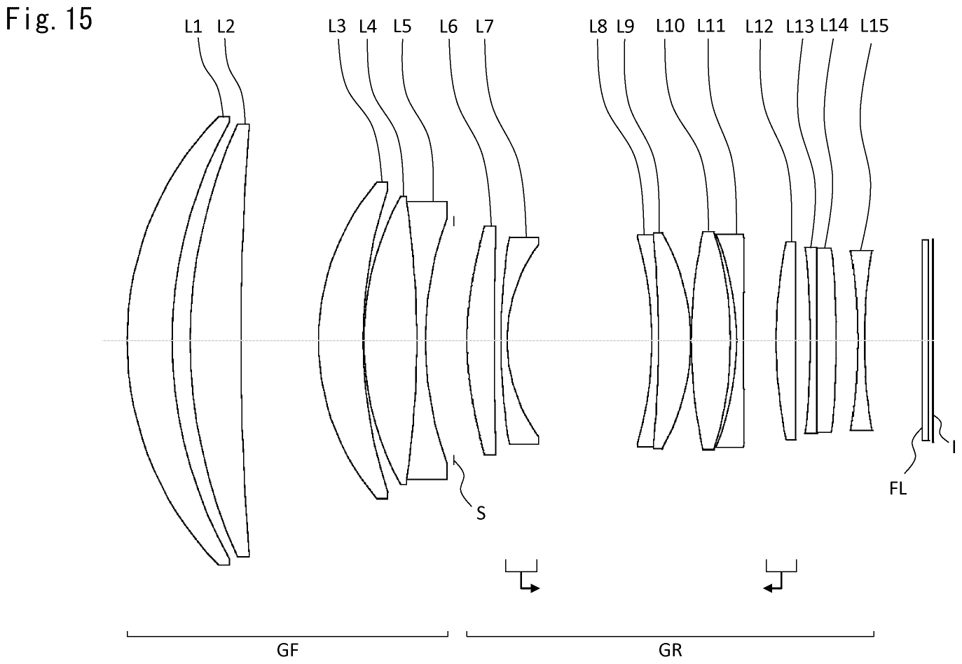

FIG. 15 is a cross-sectional view of an optical system of an eighth example focusing on an object at infinity.

The optical system of present example includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power.

The first lens group G1 consists of, in order from the object side, a meniscus-shaped positive lens L1 convex on the object side, a meniscus-shaped positive lens L2 convex on the object side, a meniscus-shaped positive lens L3 convex on the object side, a negative cemented lens composed of a biconvex positive lens L4 and a biconcave negative lens L5, an aperture stop S, and a meniscus-shaped positive lens L6 convex on the object side.

The second lens group G2 consists of a meniscus-shaped negative lens L7 convex on the object side.

The third lens group G3 consists of, in order from the object side, a positive cemented lens composed of a meniscus-shaped negative lens L8 concave on the object side and a meniscus-shaped positive lens L9 concave on the object side, a biconvex positive lens L10, and a biconcave negative lens L11.

The fourth lens group G4 consists of a planoconvex positive lens L12 convex on the object side.

The fifth lens group G5 consists of, in order from the object side, a negative cemented lens composed of a planoconcave negative lens L13 concave on the object side and a planoconvex positive lens L14 plane on the object side, and a biconcave negative lens L15.

An imaging device (not shown) constructed from CCD, CMOS, or the like is disposed on an image plane I.

A filter FL is disposed between the image plane I and the optical system of the present example.

The optical system of the present example focuses by moving the second lens group G2 and the fourth lens group G4 along the optical axis. When focus is shifted from infinity to a nearby object, the second lens group G2 moves from the object side to the image plane side, and the fourth lens group G4 moves from the image plane side to the object side.

In the optical system of the present example, the lenses from the positive lens L1 to the negative lens L5 of the first lens group G1 correspond to the front lens group, and the positive lens L6 of the first lens group G1, the second lens group G2, the third lens group G3, the fourth lens group G4, and the fifth lens group G5 correspond to the rear lens group. The second lens group G2 and the fourth lens group G4 each corresponds to a focusing group that moves at focusing. The second lens group G2 corresponds to the focusing group Gfo disposed closest to the object side. The fifth lens group corresponds to the lens group Gi disposed closest to the image plane side.

In the optical system of the present example, the positive lens L10 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L15 corresponds to the lens Li1 disposed closest to the image plane side, and the positive lens L14 corresponds to the lens Li2 disposed adjacent to the object side of the lens Li1. The positive lens L1 corresponds to the positive lens Pf of the front lens group, and the negative lens L5 corresponds to the negative lens Nf of the front lens group.

Table 8 below shows specifications of the optical system of the present example.

TABLE 8
[General specifications]

| | |
|---|---|
| f | 176.40 |
| ff | 134.07 |
| fr | −141.88 |
| TL | 185.00 |
| Bf | 15.26 |
| FNO | 1.85 |
| Y | 21.70 |

[Lens specifications]

| m | r | d | nd | νd |
|---|---|---|---|---|
| 1) | 70.7992 | 10.3651 | 1.66382 | 27.35 |
| 2) | 98.0167 | 4.1343 | | |
| 3) | 113.3096 | 11.6028 | 1.43700 | 95.10 |
| 4) | 600.8306 | 17.8278 | | |
| 5) | 53.5822 | 10.2222 | 1.43700 | 95.10 |
| 6) | 102.9859 | 0.2000 | | |
| 7) | 65.9776 | 12.1046 | 1.49782 | 82.57 |
| 8) | −209.2139 | 2.0000 | 1.85451 | 25.15 |
| 9) | 77.6880 | 6.5433 | | |
| 10) | ∞ | 3.0000 | | (aperture stop) |
| *11) | 68.8730 | 6.2390 | 1.51680 | 64.13 |
| 12) | 742.5790 | D12 | | |
| 13) | 135.0045 | 1.5000 | 1.87071 | 40.73 |
| 14) | 35.9895 | D14 | | |
| 15) | −82.8618 | 1.5000 | 2.00069 | 25.46 |
| 16) | −232.4416 | 7.3438 | 1.51680 | 64.13 |
| 17) | −48.2540 | 0.2000 | | |
| 18) | 113.4417 | 9.0000 | 1.85451 | 25.15 |
| 19) | −79.8447 | 1.3545 | | |
| 20) | −63.0212 | 1.5000 | 1.59319 | 67.90 |
| *21) | 310.8985 | D21 | | |
| 22) | 110.8901 | 4.5000 | 1.80518 | 25.45 |
| 23) | ∞ | D23 | | |
| 24) | −192.4796 | 1.5000 | 2.00069 | 25.46 |
| 25) | ∞ | 4.4712 | 1.60342 | 38.03 |
| 26) | −198.8206 | 4.9478 | | |
| *27) | −135.4173 | 1.5000 | 1.85108 | 40.12 |
| 28) | 116.3479 | 13.2022 | | |
| 29) | ∞ | 1.6000 | 1.51680 | 64.13 |
| 30) | ∞ | 1.0000 | | |

[Aspherical surface data]

| m | K | A4 | A6 | A8 | A10 |
|---|---|---|---|---|---|
| 11) | 1.0000 | −1.987E−06 | −3.988E−10 | −1.732E−13 | 2.337E−16 |
| 21) | 1.0000 | −1.638E−06 | −1.437E−09 | −3.911E−13 | 3.952E−16 |
| 27) | 1.0000 | 1.966E−07 | −5.586E−09 | 7.011E−12 | −7.933E−15 |

[Focal length data of groups]

| Groups | First surfaces | Focal lengths |
|---|---|---|
| G1 | 1 | 93.04 |
| G2 | 13 | −56.76 |
| G3 | 15 | 110.95 |
| G4 | 22 | 137.72 |
| G5 | 24 | −61.92 |

[Variable spacing data]

| | At focusing on infinity | At focusing nearby |
|---|---|---|
| D12 | 1.500 | 12.76 |
| D14 | 33.230 | 21.967 |
| D21 | 7.604 | 2.497 |
| D23 | 3.307 | 8.415 |

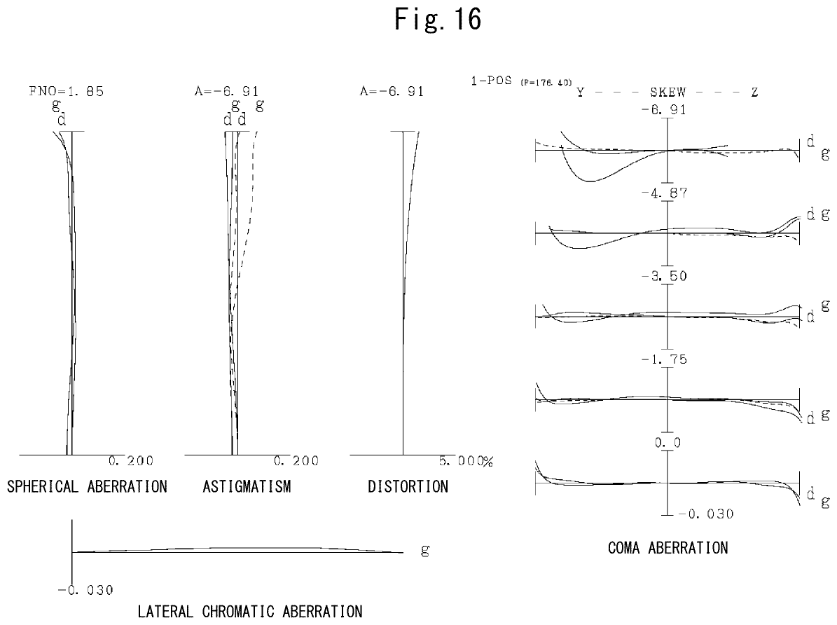

FIG. 16 shows aberrations of the optical system of the eighth example.

The graphs of aberrations suggest that the optical system of the present example corrects aberrations appropriately and has high optical performance.

### Ninth Example

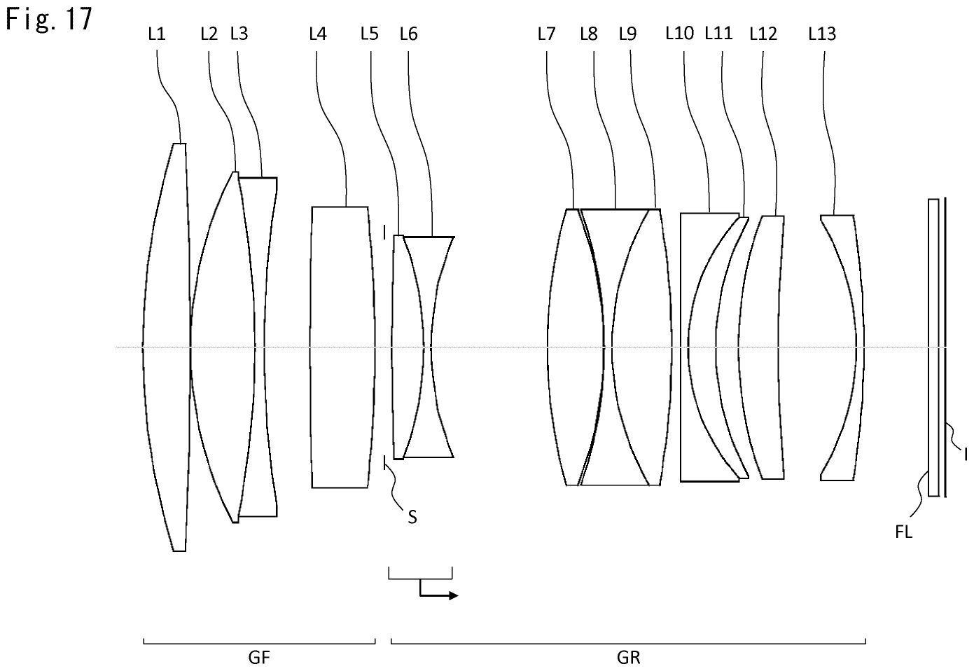

FIG. 17 is a cross-sectional view of an optical system of a ninth example focusing on an object at infinity.

The optical system of the present example includes, in order from the object side, a first lens group G1 having a positive refractive power, an aperture stop S, a second lens group G2 having a negative refractive power, and a third lens group G3 having a positive refractive power.

The first lens group G1 consists of, in order from the object side, a biconvex positive lens L1, a negative cemented lens composed of a biconvex positive lens L2 and a biconcave negative lens L3, and a biconvex positive lens L4.

The second lens group G2 consists of a negative cemented lens composed of a biconvex positive lens L5 and a biconcave negative lens L6.

The third lens group G3 consists of, in order from the object side, a biconvex positive lens L7, a negative cemented lens composed of a biconcave negative lens L8 and a biconvex positive lens L9, a negative cemented lens composed of a planoconvex negative lens L10 plane on the object side and a meniscus-shaped positive lens L11 convex on the object side, a meniscus-shaped positive lens L12 convex on the object side, and a meniscus-shaped negative lens L13 concave on the object side.

An imaging device (not shown) constructed from CCD, CMOS, or the like is disposed on an image plane I.

A filter FL is disposed between the image plane I and the optical system of the present example.

The optical system of the present example focuses by moving the second lens group G2 along the optical axis. When focusing an object at infinity to a short distance, the second lens group G2 moves from the object side to the image plane side.

In the optical system of the present example, the first lens group G1 corresponds to the front lens group, and the second lens group G2 and the third lens group G3 correspond to the rear lens group. The second lens group G2 corresponds to a focusing group that moves at focusing. The second lens group G2 corresponds to the focusing group Gfo disposed closest to the object side. The third lens group corresponds to the lens group Gi disposed closest to the image plane side.

In the optical system of the present example, the positive lens L7 corresponds to the single lens Pr having the strongest refractive index power among the biconvex single lenses in the rear lens group, and the single lens Pfoi having the strongest refractive power among the biconvex single lenses disposed closer to the image plane than the focusing group Gfo. The negative lens L13 corresponds to the lens Li1 disposed closest to the image plane side, and the positive lens L12 corresponds to the lens Li2 disposed adjacent to the object side of the lens Li1.

Table 9 below shows specifications of the optical system of the present example.

TABLE 9
[General specifications]

| | |
|---|---|
| f | 85.60 |
| ff | 78.29 |
| fr | −407.18 |
| TL | 124.99 |
| Bf | 12.15 |
| FNO | 1.85 |
| Y | 21.70 |

[Lens specifications]

| m | r | d | nd | νd |
|---|---|---|---|---|
| 1) | 103.0990 | 7.3719 | 1.88300 | 40.76 |
| 2) | −644.1714 | 0.1000 | | |
| 3) | 57.9469 | 9.9769 | 1.49782 | 82.57 |
| 4) | −128.1989 | 1.4547 | 2.00330 | 28.27 |
| 5) | 151.9669 | 7.1394 | | |
| 6) | 645.1565 | 10.0790 | 1.72916 | 54.67 |
| 7) | −201.8099 | 1.4626 | | |
| 8) | ∞ | D8 | | (aperture stop) |
| 9) | 375.9531 | 4.9280 | 1.66382 | 27.35 |
| 10) | −47.1085 | 1.2000 | 1.71700 | 47.93 |
| 11) | 42.5578 | D11 | | |
| 12) | 76.0025 | 8.7829 | 1.76385 | 48.49 |
| 13) | −56.0181 | 0.1000 | | |
| 14) | −61.6864 | 1.2000 | 1.69895 | 30.13 |
| 15) | 40.7957 | 9.2671 | 1.81600 | 46.62 |
| 16) | −118.5713 | 1.4000 | | |
| 17) | ∞ | 1.2000 | 1.63980 | 34.47 |
| 18) | 28.7079 | 4.2638 | 1.80810 | 22.76 |
| 19) | 39.6858 | 3.5350 | | |
| 20) | 55.4388 | 6.2285 | 1.88300 | 40.76 |
| 21) | 213.8631 | 12.1281 | | |
| 22) | −36.6968 | 1.2000 | 1.60342 | 38.03 |
| 23) | −124.2980 | 10.0960 | | |
| 24) | ∞ | 1.6000 | 1.51680 | 63.88 |
| 25) | ∞ | 1.0000 | | |

[Focal length data of groups]

| Groups | First surfaces | Focal lengths |
|---|---|---|
| G1 | 1 | 78.29 |
| G2 | 9 | −62.08 |
| G3 | 12 | 70.49 |

[Variable spacing data]

| | At focusing on infinity | At focusing nearby |
|---|---|---|
| D8 | 1.200 | 10.964 |
| D11 | 18.074 | 8.310 |

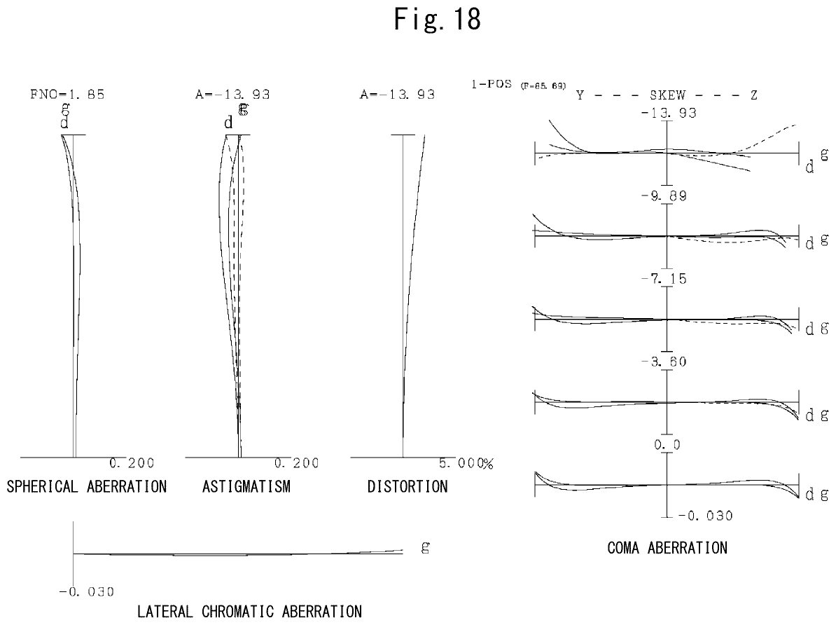

FIG. 18 shows aberrations of the optical system of the ninth example.

The graphs of aberrations suggest that the optical system of the present example corrects aberrations appropriately and has high optical performance.

### Tenth Example

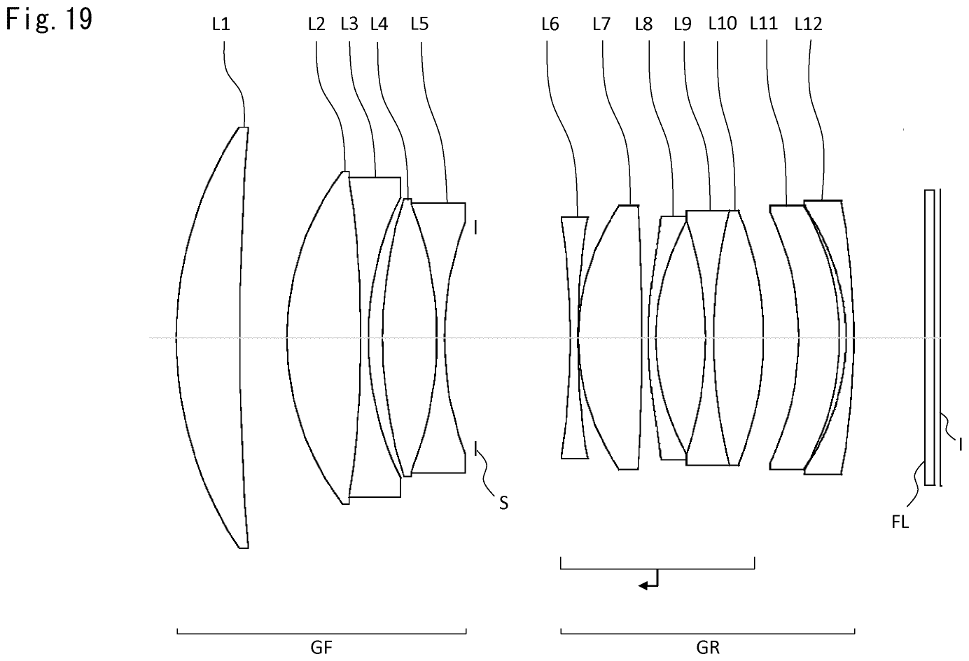

FIG. 19 is a cross-sectional view of the optical system of the tenth example focusing on an object at infinity.

The optical system of the present example includes, in order from the object side, a first lens group G1 having a positive refractive power, an aperture stop S, a second lens group G2 having a positive refractive power, and a third lens group G3 having a negative refractive power.

The first lens group G1 consists of, in order from the object side, a meniscus-shaped positive lens L1 convex on the object side, a negative cemented lens composed of a biconvex positive lens L2 and a biconcave negative lens L3, and a negative cemented lens composed of a biconvex positive lens L4 and a biconcave negative lens L5.

The second lens group G2 consists of, in order from the object side, a biconcave negative lens L6, a biconvex positive lens L7, a meniscus-shaped negative lens L8 convex on the object side, and a positive cemented lens composed of a biconcave negative lens L9 and a biconvex positive lens L10.

The third lens group G3 consists of, in order from the object side, a meniscus-shaped positive lens L11 concave on the object side, and a meniscus-shaped negative lens L12 concave on the object side.

An imaging device (not shown) constructed from CCD, CMOS, or the like is disposed on an image plane I.

A filter FL is disposed between the image plane I and the optical system of the present example.

The optical system of the present example focuses by moving the second lens group G2 along the optical axis. When focus is shifted from infinity to a nearby object, the second lens group G2 moves from the image plane side to the object side.

In the optical system of the present example, the first lens group G1 corresponds to the front lens group, and the second lens group G2 and the third lens group G3 correspond to the rear lens group. The second lens group G2 corresponds to a focusing group that moves at focusing. The second lens group G2 corresponds to the focusing group Gfo disposed closest to the object side. The third lens group corresponds to the lens group Gi disposed closest to the image plane side.

In the optical system of the present example, the positive lens L7 corresponds to the single lens Pr having the strongest refractive power among the biconvex single lens in the rear lens group. The negative lens L12 corresponds to the lens Li1 disposed closest to the image plane side, and the positive lens L11 corresponds to the lens Li2 disposed adjacent to the object side of the lens Li1.

Table 10 below shows specifications of the optical system of the present example.

TABLE 10
[General specifications]

| | |
|---|---|
| f | 100.00 |
| ff | 136.41 |
| TL | 120.00 |
| Bf | 13.15 |
| FNO | 1.85 |
| Y | 21.70 |

[Lens specifications]

| m | r | d | nd | νd |
|---|---|---|---|---|
| 1) | 57.7694 | 10.0024 | 1.59282 | 68.62 |
| 2) | 400.0000 | 7.3758 | | |
| 3) | 41.5755 | 11.6144 | 1.49782 | 82.57 |
| 4) | −164.2951 | 1.2000 | 1.73800 | 32.33 |
| 5) | 48.8315 | 2.2015 | | |
| 6) | 69.3936 | 8.4881 | 1.80810 | 22.76 |
| 7) | −54.7343 | 1.2000 | 1.74077 | 27.79 |
| 8) | 49.8276 | 4.9417 | | |
| 9) | ∞ | 14.8014 | | (aperture stop) |
| 10) | −124.6523 | 1.2000 | 1.73800 | 32.33 |
| 11) | 111.4500 | 0.1000 | | |
| 12) | 35.2246 | 10.0000 | 1.90366 | 31.34 |
| 13) | −335.2341 | 0.9386 | | |
| *14) | 57.8259 | 1.2000 | 2.00178 | 19.32 |
| 15) | 35.2792 | 7.8204 | | |
| 16) | −55.7086 | 1.2964 | 1.68893 | 31.07 |
| 17) | 78.8211 | 7.7550 | 1.88300 | 40.76 |
| 18) | −51.1472 | 5.5324 | | |
| 19) | −43.8291 | 6.4320 | 1.98613 | 16.48 |
| 20) | −39.3902 | 1.0000 | | |
| *21) | −33.3333 | 1.2000 | 1.58913 | 61.25 |
| 22) | −114.3133 | 11.1000 | | |
| 23) | ∞ | 1.6000 | 1.51680 | 63.88 |
| 24) | ∞ | 1.0000 | | |

[Aspherical surface data]

| m | K | A4 | A6 | A8 | A10 |
|---|---|---|---|---|---|
| 14) | 1.0000 | −7.051E−06 | −4.487E−09 | −9.846E−12 | 1.986E−14 |
| 21) | 1.0000 | 8.649E−07 | 3.345E−09 | 1.111E−12 | −7.577E−15 |

[Focal length data of groups]

| Groups | First surfaces | Focal lengths |
|---|---|---|
| G1 | 1 | 136.41 |
| G2 | 10 | 79.30 |
| G3 | 19 | −111.58 |

[Variable spacing data]

| | At focusing on infinity | At focusing nearby |
|---|---|---|
| D9 | 14.801 | 2.270 |
| D18 | 5.532 | 18.064 |

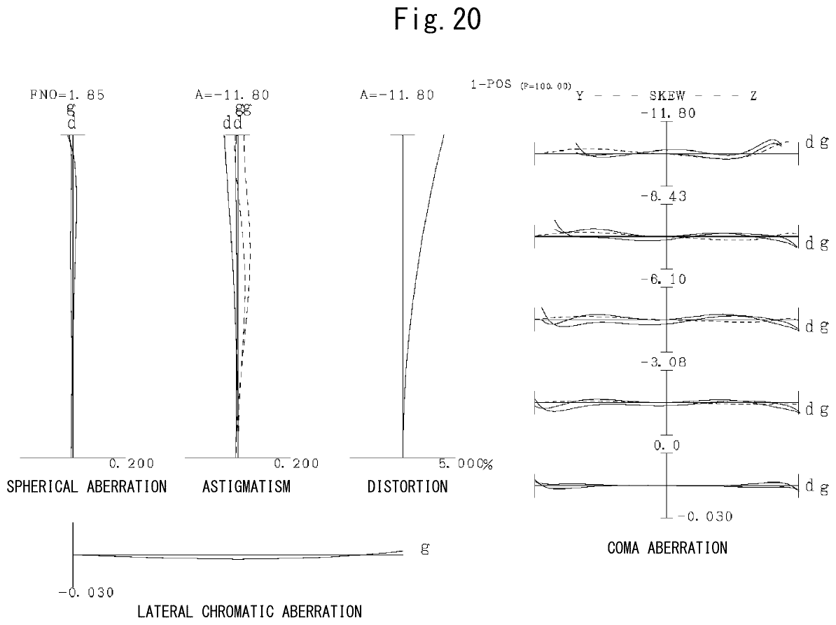

FIG. 20 shows aberrations of the optical system of the tenth example.

The graphs of aberrations suggest that the optical system of the present example corrects aberrations appropriately and has high optical performance.

An optical system of small size and good optical performance can be achieved according to the above examples.

Values for the conditional expressions of the examples are listed below.

TL is the total length of the optical system; f is the focal length of the optical system; and Bf is the back focal length in air. ff is the focal length of the front lens group; and fr is the focal length of the rear lens group. fPr is the focal length of the single lens Pr; fPfol is the focal length of the single lens Pfoi; and ffo is the focal length of the focusing group Gfo.

tr is the sum of the central thicknesses of the lens included in the rear lens group; and tGi is the sum of the lengths on the optical axis of the lenses included in the lens group Gi. Da is a distance on the optical axis between the lens surface on the object side of Li1 and the lens surface on the image plane side of the lens Li2 at infinity in focus. D1 is the distance on the optical axis between the lens surface closest to the object side and the object-side surface of the single lens Pr at infinity in focus; and D2 is the distance on the optical axis between the aperture stop and the object-side surface of the single lens Pr.

ndPf is the refractive index of the positive lens Pf at d-line; vdPf is the Abbe number based on d-line of the positive lens Pf; and θFPf is the partial dispersion ratio of the positive lens Pf. ndNf is the refractive index of the negative lens Nf at d-line; vdNf is the Abbe number based on d-line of the negative lens Nf; and θFNf is the partial dispersion ratio of the negative lens Nf.

### [Values for Conditional Expressions]

| Conditional expressions | First | Second | Third | Fourth | Fifth |
|---|---|---|---|---|---|
| (1) ff/\|fr\| | 0.499 | 0.850 | 0.571 | 0.324 | 0.257 |
| (2) tr/TL | 0.283 | 0.220 | 0.239 | 0.172 | 0.252 |
| (3) f/TL | 0.897 | 0.912 | 0.912 | 0.908 | 0.897 |
| (4) fPr/\|fr\| | 0.221 | 0.582 | 0.284 | 0.193 | 0.120 |
| (5) fPfoi/\|fr\| | 0.221 | 0.582 | 0.284 | 0.193 | 0.120 |
| (6) fPfoi/f | 0.379 | 0.440 | 0.422 | 0.401 | 0.450 |
| (7) Da/Bf | 0.310 | 0.347 | 0.347 | 0.163 | 0.287 |
| (8) tGi/Da | 2.210 | 2.043 | 1.961 | 0.340 | 2.406 |
| (9) D1/TL | 0.605 | 0.576 | 0.571 | 0.635 | 0.603 |
| (10) D2/TL | 0.292 | 0.228 | 0.262 | 0.322 | 0.286 |
| (11) \|ffo\|/f | 0.523 | 0.509 | 0.571 | 0.589 | 0.554 |
| (12) ndPf | 1.664 | 1.664 | 1.664 | 1.664 | 1.664 |
| (13) νdPf | 27.350 | 27.350 | 27.350 | 27.350 | 27.350 |
| (14) θFPf-(0.6415- | 0.035 | 0.035 | 0.035 | 0.035 | 0.035 |
| 0.00162* ν dPf) | | | | | |
| (15) ndNF | 1.855 | 1.855 | 1.855 | 1.855 | 1.855 |
| (16) νdNf | 25.150 | 25.150 | 25.150 | 24.800 | 25.150 |
| (17) θFNf-(0.6415- | 0.010 | 0.010 | 0.010 | 0.011 | 0.010 |
| 0.00162* ν dNf) | | | | | |

| Conditional expressions | Sixth | Seventh | Eighth | Ninth | Tenth |
|---|---|---|---|---|---|
| (1) ff/\|fr\| | 0.632 | 0.683 | 0.945 | 0.192 | 0.688 |
| (2) tr/TL | 0.260 | 0.256 | 0.211 | 0.306 | 0.242 |
| (3) f/TL | 0.843 | 0.936 | 0.954 | 0.685 | 0.833 |
| (4) fPr/\|fr\| | 0.272 | 0.297 | 0.395 | 0.107 | 0.180 |
| (5) fPfoi/\|fr\| | 0.272 | 0.297 | 0.395 | 0.107 | 0.180 |
| (6) fPfoi/f | 0.395 | 0.382 | 0.318 | 0.508 | 0.357 |
| (7) Da/Bf | 0.242 | 0.284 | 0.324 | 0.998 | 0.076 |
| (8) tGi/Da | 2.950 | 1.967 | 1.510 | 2.650 | 7.632 |
| (9) D1/TL | 0.524 | 0.660 | 0.700 | 0.504 | 0.526 |
| (10) D2/TL | 0.247 | 0.359 | 0.295 | 0.203 | 0.134 |
| (11) \|ffo\|/f | 0.624 | 0.513 | 0.322 | 0.725 | 0.793 |
| (12) ndPf | 1.664 | 1.664 | 1.664 | — | 1.808 |
| (13) νdPf | 27.350 | 27.350 | 27.350 | — | 22.760 |
| (14) θFPf-(0.6415- | 0.035 | 0.035 | 0.035 | — | 0.026 |
| 0.00162* ν dPf) | | | | | |
| (15) ndNf | 1.855 | 1.855 | 1.855 | — | — |
| (16) νdNf | 25.150 | 25.150 | 25.150 | — | — |
| (17) θFNf-(0.6415- | 0.010 | 0.010 | 0.010 | — | — |
| 0.00162* ν dNf) | | | | | |

The above examples are specific examples of the present invention, and the present invention is not limited thereto. The following details can be appropriately employed unless the optical performance of the optical system of the embodiment of the present application is compromised.

In the optical system of the present embodiment, an optical member such as a filter between the lens surface closest to the image plane and the image plane may be omitted.

The optical system of the present embodiment may include a vibration reduction lens group configured to make a movement including a component in a direction perpendicular to the optical axis to correct an image blur caused by hand-held camera shake. The vibration reduction lens group may be a lens group or a sub-lens group comprising one or more lens components included in a lens group. A “lens component” refers to a single lens or a cemented lens made by bonding multiple lenses together.

In the optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment. In addition, spherical or plane lens surfaces are preferable because depiction performance does not decrease much when the image plane is shifted.

An aspherical lens surface may be formed by grinding glass or glass molding with a mold having an aspherical shape, or formed on the surface of resin bonded on a glass surface. In the optical system of the present embodiment, lens surfaces may be diffractive surfaces, and lenses may be graded index lenses (GRIN lenses) or plastic lenses.

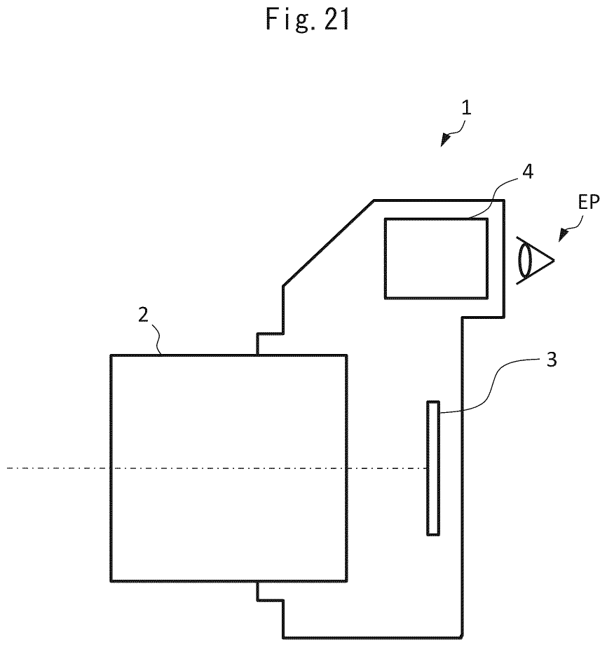

Next, a camera including the optical system of the present embodiment will be described with reference to FIG. 21. FIG. 21 schematically shows a camera including an optical system of the present embodiment.

The camera 1 is an example of an optical device, and is a “mirror-less camera” having an interchangeable lens including the optical system according to the first example as an imaging lens 2.

In the camera 1, light from an object (subject) (not shown) is condensed by the imaging lens 2 and reaches an imaging device 3. The imaging device 3 converts light from the subject to image data. The image data is displayed on an electronic view finder 4. This enables a photographer who positions his/her eye at an eye point EP to observe the subject.

When a release button (not shown) is pressed by the photographer, the image data is stored in a memory (not shown). In this way, the photographer can take a picture of the subject with the camera 1.

The optical system of the first example included in the camera 1 as the imaging lens 2 is an optical system of small-sized and favorable optical performance. Thus the camera 1 can achieve smaller size and favorable optical performance. A camera configured by including any of the optical systems of the second to tenth examples as the imaging lens 2 can have the same effect as the camera 1.

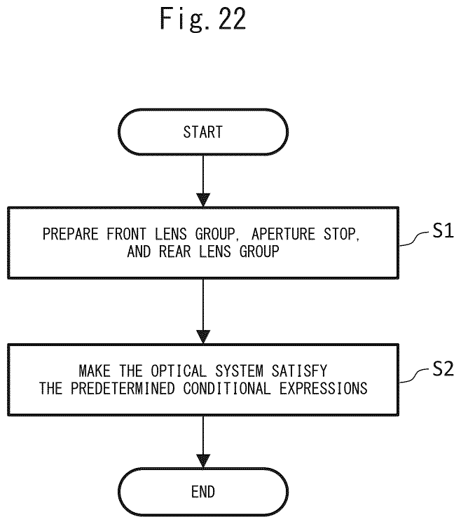

Finally, a method for manufacturing an optical system of the present embodiment will be outlined with reference to FIG. 22.

FIG. 22 is a flowchart outlining a method for manufacturing an optical system of the present embodiment. The method for manufacturing an optical system of the present embodiment shown in FIG. 22 includes steps S11 to S12 below.

Step S11: the front lens group, the aperture stop S, and the rear lens group are prepared.

Step S12: The optical system is made to satisfy the following conditional expressions.

$$0.10 < ff / \vert fr \vert < 1.5 \qquad ( 1 )$$

$$0.13 < tr / TL < 0.45 \qquad ( 2 )$$

$$0.5 < f / TL < 1.2 \qquad ( 3 )$$

where
ff: the focal length of the front lens group
fr: the focal length of the rear lens group
tr: the sum of the central thicknesses of the lenses included in the rear lens group
TL: the total length of the optical system
f: the focal length of the optical system

An optical system of small-sized favorable imaging performance can be manufactured by the method for manufacturing a variable magnification optical system of the present embodiment.

It should be noted that those skilled in the art can make various changes, substitutions, and modifications without departing from the spirit and scope of the present disclosure.

What is claimed is:

1. An optical system comprising, in order from an object side, a front lens group having positive refractive power, an aperture stop, and a rear lens group,
wherein the following conditional expressions are satisfied.
$$0.10 < ff / \vert fr \vert < 1.5 \\ 0.13 < tr / TL < 0.45 \\ 0.5 < f / TL < 1.2$$
where
ff: the focal length of the front lens group
fr: the focal length of the rear lens group
tr: the sum of the central thicknesses of the lenses included in the rear lens group
TL: the total length of the optical system
f: the focal length of the optical system

2. The optical system according to claim 1, wherein the rear lens group has a negative refractive power.

3. The optical system according to claim 1, wherein the following conditional expression is satisfied.
$$0.05 < fPr / \vert fr \vert < 0. 70$$
where
fPr: the focal length of a single lens Pr having the strongest refractive power among biconvex single lenses in the rear lens group

4. The optical system according to claim 1, comprising at least one focusing group configured to move at focusing, wherein the following conditional expression is satisfied.
$$0.05 < fPfoi / \vert fr \vert < 0. 50$$
where
fPfoi: the focal length of a single lens Pfoi having the strongest refractive power among biconvex single lenses disposed closer to the image plane side than a focusing group Gfo disposed closest to the object side among at least one focusing group

5. The optical system according to claim 1, comprising at least one focusing group configured to move at focusing, wherein the following conditional expression is satisfied.
$$0.25 < fPfoi / f < 0.55$$
where
fPfoi: the focal length of a single lens Pfoi having the strongest refractive power among biconvex single lenses disposed closer to the image plane side than a focusing group Gfo disposed closest to the object side among at least one focusing group

6. The optical system according to claim 1, wherein the following conditional expression is satisfied.
$$0.05 < Da / Bf < 1.10$$
where
Da: the distance on the optical axis between a lens surface on the object side of a lens Li1 disposed closest to the image plane side and a lens surface on the image plane side of a lens Li2 disposed adjacent to the object side of the lens Li1 at focusing on infinity
Bf: back focal length in air

7. The optical system according to claim 1, wherein the rear lens group comprises a plurality of lens groups including at least one focusing group that moves at focusing,
the distances between the lens groups are varied at focusing, and
the following conditional expression is satisfied.
$$0.3 < tGi / Da < 9.00$$
where
tGi: the sum of the lengths on the optical axis of the respective lenses included in a lens group Gi disposed closest to the image plane among the plurality of lens groups
Da: the distance on the optical axis between a lens surface on the object side of a lens Li1 disposed closest to the image plane side and a lens surface on the image plane side of a lens Li2 disposed adjacent to the object side of the lens Li1 at focusing on infinity

8. The optical system according to claim 1, wherein the following conditional expression is satisfied.
$$0.4 < D 1 / TL < 0.85$$
where
D1: the distance on the optical axis between the lens surface closest to the object side and the object-side surface of a single lens Pr having the strongest refractive power among biconvex single lenses in the rear lens group at focusing on infinity

9. The optical system according to claim 1, wherein the following conditional expression is satisfied.
$$0.10 < D 2 / TL < 0.80$$
where
D2: the distance on the optical axis between the aperture stop and the object-side lens surface of a single lens Pr having the strongest refractive power among biconvex single lenses in the rear lens group

10. The optical system according to claim 1, comprising at least one focusing group that moves at focusing, wherein the following conditional expression is satisfied.
0.25<|ffo|/f<0.90
where
ffo: the focal length of a focusing group Gfo disposed closest to the object side among the at least one focusing group

11. The optical system according to claim 1, wherein the front lens group comprises at least one positive lens Pf satisfying the following conditional expressions.
$$1.6 < ndPf \\ vdPf < 31. \\ 0.01 < θ gFPf - ( 0.6 \; 415 - 0.00162 \times vdPf )$$
where
ndPf: the refractive index at d-line of the positive lens Pf
vdPf: the Abbe number based on d-line of the positive lens Pf
θgFPf: the partial dispersion ratio of the positive lens Pf defined by the following expression:
$$θ gFPf = ( ngPf - nFPf ) / ( nFPf - nCPf )$$
where ngPf, nFPf, and nCPf denote the refractive indices of the positive lens Pf at g-line, F-line, and C-line, respectively.

12. The optical system according to claim 1, wherein the front lens group comprises at least one negative lens Nf satisfying the following conditional expressions.
$$1. 85 < ndNf \\ vdNf < 26.00 \\ θ gFNf - ( 0.6 \; 415 - 0.00162 \times vdNf ) < 0. 015$$
where
ndNf: the refractive index at d-line of the negative lens Nf
vdNf: the Abbe number based on d-line of the negative lens Nf
θgFNf: the partial dispersion ratio of the negative lens Nf defined by the following expression.
where ngNf, nFNf, and nCNf denotes the refractive indices of the negative lens Nf at g-line, F-line, and C-line, respectively.

13. An optical device comprising the optical system according to claim 1.

14. An interchangeable lens comprising the optical system according to claim 1.

15. A method for manufacturing an optical system, the method comprising configuring an optical system including, in order from an object side, a front lens group having a positive refractive power, an aperture stop, and a rear lens group, and
the following conditional expressions are satisfied.
$$0.10 < ff / \vert fr \vert < 1.5 \\ 0.13 < tr / TL < 0.45 \\ 0.5 < f / TL < 1.2$$
where
ff: the focal length of the front lens group
fr: the focal length of the rear lens group
tr: the sum of the central thicknesses of the lenses included in the rear lens group
TL: the total length of the optical system
f: the focal length of the optical system
